(19) United States
(12) Patent Application Publication
(10) Pub. No.: US 2018/0250730 A1
(43) Pub. Date: Sep. 6, 2018

(54) SPINDLE ROTATION UNIT AND PROCESSING TABLE STRUCTURE OF CAN MANUFACTURING APPARATUS

(71) Applicant: Universal Can Corporation, Tokyo (JP)

(72) Inventors: Shouji MATSUO, Yuki-shi (JP); Ryosuke KUSUBASHI, Oyama-shi (JP); Tetsuya OHSE, Yuki-shi (JP); Takafumi SATO, Nagaoka-shi (JP)

(73) Assignee: Universal Can Corporation, Tokyo (JP)

(21) Appl. No.: 15/759,126

(22) PCT Filed: Mar. 22, 2017
(86) PCT No.: PCT/JP2017/011334

§ 371 Date: Mar. 9, 2018

(30) Foreign Application Priority Data
May 24, 2016 (JP) 2016-103435
May 27, 2016 (JP) 2016-106553

(51) Int. Cl. B21D 51/26

(52) U.S. Cl. CPC B21D 51/2623; F16H 7/12; B21D 51/2607

(57) ABSTRACT

A spindle rotation unit includes: a plurality of attachment portions that are arranged in a base; a spindle that is rotatably attached to any one of the plurality of attachment portions; a motor plate that is attached to the base; a motor attachment flange that is attached to the motor plate; a driving motor that is attached to the motor attachment flange; and a transfer member that connects the driving motor and the spindle and transfers a rotational driving force of the driving motor to the spindle. The motor attachment flange is provided with an opening portion through which the transfer member is inserted and the motor attachment flange is disposed in the motor plate to allow its position to be adjustable so that the opening portion is opened toward a predetermined attachment portion to which the spindle is attached among the plurality of attachment portions.

### CROSS-REFERENCE TO RELATED PATENT APPLICATIONS

This application is a U.S. National Phase Application under 35 U.S.C. § 371 of International Patent Application No. PCT/JP2017/011334 filed on Mar. 22, 2017 and claims the benefit of Japanese Patent Applications No. 2016-103435 filed on May 24, 2016 and No. 2016-106553 filed on May 27, 2016, all of which are incorporated herein by reference in their entireties. The International Application was published in Japanese on Nov. 30, 2017 as International Publication No. WO/2017/203813 under PCT Article 21(2).

### FIELD OF THE INVENTION

The present invention relates to a spindle rotation unit such as a rotational processing tool driving structure for rotationally driving, for example, a rotational processing tool provided in a processing table of a can manufacturing apparatus.

Further, the present invention relates to a processing table structure of a can manufacturing apparatus.

### BACKGROUND OF THE INVENTION

Conventionally, as a can manufacturing apparatus for manufacturing bottle cans, aerosol cans, and the like made of an aluminum alloy material or the like, for example, a can manufacturing apparatus described in Japanese Unexamined Patent Application, First Publication No. 2005-329424 below is known.

The can manufacturing apparatus includes a holding table and a processing table that are disposed to face each other. The holding table is generally called a turntable and the processing table is generally called a die table. These tables are formed in a disk shape or a circular ring shape, the center axes (the table axes) thereof extend in the horizontal direction, and the center axes of the tables are coaxially disposed.

A plurality of bottomed cylinder cans that are workpieces are held by the holding table in the table circumferential direction around the table axis. A plurality of processing tools for processing the cans are arranged in the processing table in the table circumferential direction. Specifically, the processing table is provided with a plurality of attachment holes (attachment portions) arranged in the table circumferential direction to penetrate the table in the table axial direction and the plurality of processing tools are attached to the attachment holes according to a can processing procedure.

The plurality of processing tools include a die processing tool and a rotational processing tool. The die processing tool moves in the can axial direction (a direction parallel to the table axis) with respect to the can and performs die processing such as drawing processing for decreasing the diameter of the circumferential wall of the can or expanding processing for increasing the diameter of the circumferential wall. The rotational processing tool rotates around the can axis with respect to the can and performs rotational processing such as trimming processing, screw forming processing, curl processing, and throttle (curl caulking) processing on the circumferential wall of the can using the rotation around the can axis.

The holding table and the processing table are repeatedly moved closer to and away from each other in the table axial direction by a table driving unit provided in a main body frame of the can manufacturing apparatus and are intermittently and relatively rotated in the table circumferential direction. Specifically, the processing table is moved closer to and away from the holding table in the table axial direction and the holding table is rotated by a predetermined amount in the table circumferential direction with respect to the processing table during one approaching/separating stroke (reciprocating movement).

For each stroke in which the tables move closer to and away from each other, a can is processed and the can is moved to a processing position using a next processing tool.

When this operation is repeated, the can held by the holding table is sequentially processed by the plurality of processing tools provided in the processing table and a can (a bottle can or an aerosol can) having a desired shape has been manufactured at a time point at which a processing series ends.

As a screw forming processing tool for performing screw forming processing among rotational processing tools, for example, a tool described in Japanese Unexamined Patent Application, First Publication No. 2004-74170 is known.

This screw forming processing tool (screw forming device) includes an inner member that is inserted into a can and is disposed to face an inner peripheral surface of a mouth portion of the can (a circumferential wall of the can) and an outer member that is disposed to face an outer peripheral surface of the mouth portion. The center member and the outer member sandwich the mouth portion of the can therebetween and are rotated (revolved) around the can axis over the entire periphery of the mouth portion while reversely rotating (spinning) around respective axes thereof in synchronization by a gear mechanism or the like so that both members roll on the mouth portion. Accordingly, screw forming processing is performed on the mouth portion.

The screw forming processing tool including the center member and the outer member has an outer diameter larger than that of the rotational processing tool other than the die processing tool or the screw forming processing tool among the processing tools due to the structure thereof. For this reason, the plurality of attachment holes formed in the processing table include a small diameter attachment hole (a general attachment hole) to which processing tools other than the screw forming processing tool are attached and a large diameter attachment hole (an attachment hole dedicated for the screw forming processing tool) to which the screw forming processing tool is attached.

Processing using the screw forming processing tool is completed with only one stroke for the can. For this reason, a conventional processing table is provided with only one large diameter attachment hole to which the screw forming processing tool is attachable.

### SUMMARY OF INVENTION

### Technical Problem

However, the conventional can manufacturing apparatus has the following problems to be solved.

A driving motor for rotating the rotational processing tool around the can axis with respect to the can is attached to the processing table. The driving motor is connected to a tool spindle (a spindle) of the rotational processing tool and rotates the tool spindle to rotate the rotational processing tool. Conventionally, the driving motor is directly fixed to the processing table (base) and is disposed in a one-to-one relationship only with respect to a predetermined attachment hole in which the rotational processing tool is disposed among the plurality of attachment holes of the processing table. That is, the driving motor cannot be disposed to correspond to an attachment hole other than this predetermined attachment hole.

For this reason, even when there is a demand to change the arrangement order of the plurality of processing tools arranged in the processing table in the table circumferential direction in order to perform a different type of processing on the can, the rotational processing tool cannot be moved from the current position (the predetermined attachment hole) and thus the can processing types (variations) are limited.

For the configuration of, for example, a can painting apparatus or a can inspection apparatus other than a can manufacturing apparatus, a configuration may be conceived in which cans are held by a plurality of chucks (attachment portions) arranged in the table (base) and spindles of the chucks are rotated by driving motors so that the chucks are rotated.

The application of the above-described configuration is not limited to a can manufacturing apparatus, a can painting apparatus, and a can inspection apparatus and a spindle rotation unit used in a workpiece processing (including manufacturing, painting, inspection, and other various processes) apparatus may generally adopt the above-described configuration. That is, the spindle rotation unit includes a plurality of attachment portions arranged in a base, a spindle that is rotatably attached to a predetermined attachment portion among the plurality of attachment portions, and a driving motor that is directly attached to the base and rotates the spindle.

Conventionally, there is a case in which the driving motor cannot be disposed to correspond to a spindle again when the position of the spindle is changed to another attachment portion other than one attachment portion in which the spindle was disposed among the plurality of attachment portions in the spindle rotation unit even when the driving motor can be disposed at a position corresponding to one attachment portion.

An aspect of the present invention has been made in view of such circumstances and an object thereof is to provide a spindle rotation unit in which a driving motor for rotating a spindle can be easily disposed to correspond to a spindle even when the arrangement position of a spindle attached to one of a plurality of attachment portions arranged in a base is changed.

Further, the conventional can manufacturing apparatus has the following problems to be solved. For example, in a case in which a bottle can is manufactured by performing screw forming processing on the mouth portion, a plurality of different types of bottle can each having a different diameter of mouth portion cannot be manufactured by sharing one can manufacturing apparatus.

Specifically, for example, when the processing steps using the can manufacturing apparatus are compared between a bottle can having a diameter of 38 mm and a bottle can having a diameter of 28 mm that have the same outer diameter but have different diameters of mouth portions, the number of times of die processing on the can before screw forming processing are different. That is, the number of times of die processing (particularly, the number of times of drawing processing) of the bottle can having a small diameter of 28 mm is larger than that of the bottle can having a diameter of 38 mm.

For this reason, for bottle cans having different diameters, the screw forming processing tool cannot be set to the same attachment position in the processing table and thus bottle cans having different diameters cannot be manufactured by the same can manufacturing apparatus. That is, there is a case in which the screw forming processing tool of the processing table cannot be positioned in the large diameter attachment hole (the attachment hole dedicated for the screw forming processing tool) at the time of manufacturing bottle cans having different diameters.

Further, in recent years, there has been a demand for a long neck type bottle can. The long neck type bottle can has a long neck shape, for example, as shown in FIGS. 14 and 15 and a neck portion 2104 extending in the can axial direction is formed between a mouth portion 2103 and a shoulder portion 2102 of a can body (a circumferential wall of the can) 2101 of a can 2100. In the conventional can manufacturing apparatus, screw forming processing can be performed on the mouth portion 2103, but embossing processing cannot be performed on the neck portion 2104.

Specifically, an embossing tool corresponding to a rotational processing tool needs to be provided in the processing table in order to perform embossing processing on the neck portion. However, there has been no technical idea of providing an embossing tool in a can manufacturing apparatus in the related art. Here, for example, as such an embossing tool, a novel configuration including a center member inserted into a can and disposed to face the inner peripheral surface of a neck portion (the circumferential wall of the can) of the can and an outer member disposed to face the outer peripheral surface of the neck portion can be used. In this case, the center member and the outer member sandwich the neck portion of the can therebetween and are rotated (revolved) around the can axis in the periphery of the neck portion while reversely rotating (spinning) around respective axes thereof in synchronization using a gear mechanism or the like so that both members roll on the neck portion. Accordingly, embossing processing is performed on at least a part of the neck portion.

The embossing tool has substantially the same structure as that of the screw forming processing tool and the outer peripheral surfaces of the center member and the outer member are formed in an uneven shape for embossing processing instead of an uneven shape for screw forming processing. In view of the structure, the embossing tool also has a large outer diameter similarly to the screw forming processing tool. Thus, the embossing tool can be attached only to the large diameter attachment hole among the plurality of attachment holes formed in the processing table. For this reason, in the conventional can manufacturing apparatus, both the screw forming processing tool and the embossing tool cannot be disposed in the processing table.

In a case in which a bottle can or an aerosol can is manufactured, for example, there may be demand for performing a plurality of types of embossing processing on the can body (the circumferential wall of the can). However, the conventional can manufacturing apparatus cannot cope with such a demand.

Another aspect of the present invention has been made in view of the above-described circumstances and an object thereof is to provide a processing table structure of a can manufacturing apparatus capable of variously processing cans that could not be processed conventionally by providing a plurality of large outer diameter rotational processing tools in a processing table to manufacture, for example, a plurality of cans having different diameters with one can manufacturing apparatus, to perform both screw forming processing and embossing processing on the can, or to perform a plurality of types of embossing processing on the can.

### Solution to Problem

According to an aspect of the present invention, there is provided a spindle rotation unit including: a plurality of attachment portions that are arranged in a base; a spindle that is rotatably attached to any one of the plurality of attachment portions; a motor plate that is attached to the base; a motor attachment flange that is attached to the motor plate; a driving motor that is attached to the motor attachment flange; and a transfer member that connects the driving motor and the spindle and transfers a rotational driving force of the driving motor to the spindle, wherein the motor attachment flange is provided with an opening portion through which the transfer member is inserted, and wherein the motor attachment flange is disposed in the motor plate to allow its position to be adjustable so that the opening portion is open toward a predetermined attachment portion to which the spindle is attached among the plurality of attachment portions.

In the spindle rotation unit of the present invention, the plurality of attachment portions are arranged in the base. The spindle is rotatably attached to one of the attachment portions (for example, one attachment portion) among the plurality of attachment portions. The motor plate is attached to the base.

The motor attachment flange is attached to the motor plate and the driving motor is attached to the motor attachment flange. That is, the driving motor is disposed on the base via the motor attachment flange and the motor plate. The driving motor and the spindle are connected to each other through the transfer member such as a belt inserted through the opening portion of the motor attachment flange.

According to the present invention, the motor attachment flange can be attached to the motor plate while the position is adjusted so that the opening portion of the motor attachment flange is open toward a predetermined attachment portion to which the spindle is attached among the plurality of attachment portions arranged in the base.

Thus, since the opening portion of the motor attachment flange can become reliably open toward the spindle irrespective of which one of the plurality of attachment portions of the base to which the spindle is attached, the transfer member can be reliably inserted through the opening portion.

That is, the rotational driving force of the driving motor can be stably transferred to the spindle by the transfer member regardless of the attachment position of the spindle without any interference between the motor attachment flange and the transfer member inserted through the opening portion of the motor attachment flange. For this reason, it is possible to freely select a predetermined attachment portion in which the spindle is disposed in the base among the plurality of attachment portions.

As described above, according to an aspect of the present invention, it is possible to easily dispose the driving motor for rotating the spindle to correspond to the spindle even when the arrangement position of the spindle attached to one of the plurality of attachment portions arranged in the base is changed.

Further, since the above-described operational effects can be obtained by a simple operation in which the opening portion of the motor attachment flange is adjusted to face the spindle even when the spindle is disposed at a new attachment portion among the plurality of attachment portions, workability is satisfactory.

In the spindle rotation unit, the transfer member may be an annular belt, a belt tensioner may be attached to the motor plate, and the belt tensioner may be disposed in the motor plate so that its position is adjustable in response to the predetermined attachment portion to which the spindle is attached among the plurality of attachment portions.

According to an aspect of the present invention, as described above, the spindle can be attached to any attachment portion among the plurality of attachment portions arranged in the base. For that reason, the position of the transfer member wound (wrapped) around the spindle and the driving motor also changes in response to the attachment position of the spindle.

Here, when the position of the belt tensioner attached to the motor plate is adjustable as in the above-described configuration, it is possible to apply a desired tension by reliably bringing the belt tensioner into contact with the belt even when the position of the belt corresponding to the transfer member changes in response to the attachment position of the spindle.

According to the above-described configuration, since a tensile force (a tension load or a tension) of the belt corresponding to the transfer member can be stably maintained at a predetermined value or more regardless of the attachment position of the spindle, the rotational driving force of the driving motor can be efficiently and stably transferred to the spindle. When a distance between the spindle and the driving motor greatly changes in response to the attachment position of the spindle, the belt of the transfer member may be appropriately changed in size or replaced.

In the spindle rotation unit, the motor attachment flange may be attached to the motor plate while rotating around a motor axis of the driving motor so that its position is adjustable.

In the above-described configuration, since the motor attachment flange is reattached to the motor plate while rotating around the motor axis, the opening portion of the motor attachment flange can be disposed to face the spindle. For this reason, it is easy to perform an operation in which the position of the opening portion of the motor attachment flange is adjusted to be open toward a predetermined attachment portion to which the spindle is attached among the plurality of attachment portions arranged in the base and the position of the driving motor having a large weight (the position of the motor axis) is not changed before and after the position is adjusted.

Even when the arrangement position of the spindle in the base is changed, the position of the motor attachment flange can be adjusted without substantially changing the arrangement of the driving motor by rotating the motor attachment flange around the motor axis, the weight balance of the base does not greatly change and the workpiece processing apparatus including the spindle rotation unit can stably process a workpiece. Accordingly, products are manufactured with a good product quality.

In the spindle rotation unit, it is preferable that the driving motor is supported by the motor attachment flange in a region of at least 180° or more around the motor axis.

In this case, since a sufficiently wide region in which the motor attachment flange supports the driving motor can be secured while forming the opening portion in the motor attachment flange so that the transfer member is inserted therethrough, a state in which the driving motor is supported by the motor attachment flange is stabilized. That is, since the driving motor is supported by the motor attachment flange in a region of 180° or more around the motor axis including both outer portions in the radial direction around the motor axis, the attachment stability of the driving motor with respect to the motor attachment flange is secured.

In the spindle rotation unit, the base may be a table and the plurality of attachment portions may be arranged over an entire periphery of the table in a table circumferential direction around a table axis.

In this case, it is possible to obtain the above-described operational effects of the present invention over the entire periphery of the table (base) in the table circumferential direction. Since the plurality of attachment portions are arranged over the entire periphery of the table, the spindle can be freely disposed at any one of the attachment portions and thus various processes can be performed on the workpiece.

In the spindle rotation unit, the table may include an inner ring body, an outer ring body that is disposed outward of the inner ring body in a table radial direction orthogonal to the table axis to be coaxial therewith, and a plurality of ribs that connect the inner ring body and the outer ring body in the table radial direction and are arranged at intervals in the table circumferential direction, the plurality of attachment portions may be arranged in at least one of the outer ring body and the inner ring body, and a width of the motor plate in the table circumferential direction may be set to be smaller than a distance in the table circumferential direction between the ribs adjacent to each other in the table circumferential direction.

In the above-described configuration, the table (base) is formed in a double ring shape including the inner ring body and the outer ring body and the ring bodies are connected to each other by the plurality of ribs arranged in the table circumferential direction. Since the width of the motor plate (the length in the table circumferential direction) is set to be smaller than the distance between adjacent ribs in the table circumferential direction (the length in the table circumferential direction), the motor plate can be disposed to be received between the ribs.

In this case, the motor plate can be easily disposed in the table without, for example, a troublesome operation of securing a space for attaching the motor plate by cutting a part of the plurality of ribs arranged densely in the table circumferential direction. Accordingly, the strength of the table is also stably secured.

Since it is possible to easily adjust the height positions in the motor axial direction (or the spindle axial direction) of the spindle and the driving motor attached to the motor plate through the motor attachment flange, the spindle and the driving motor can be easily and reliably connected to each other using the transfer member and thus the connection state is also stabilized.

According to another aspect of the present invention, there is provided a processing table structure of a can manufacturing apparatus in which a holding table and a processing table disposed to face each other repeatedly move closer to and away from each other in a table axial direction and are intermittently and relatively rotated in a table circumferential direction around a table axis and thereby sequentially process a bottomed cylinder can held by the holding table using a plurality of processing tools provided in the processing table in the table circumferential direction, wherein the processing table is provided with a plurality of attachment holes arranged in the table circumferential direction so that the processing tools are attachable thereto, wherein the plurality of attachment holes include a first attachment hole and a second attachment hole having an inner diameter larger than that of the first attachment hole, and wherein at least two or more second attachment holes are provided in the processing table.

According to the present invention, the plurality of attachment holes arranged in the processing table in the table circumferential direction include the first attachment hole and the second attachment hole having an inner diameter larger than that of the first attachment hole. At least two or more second attachment holes are formed in the processing table. For this reason, since the large outer diameter rotational processing tool (for example, the screw forming processing tool or the embossing tool) can be attached to the plurality of second attachment holes, as will be described below, it is possible to variously process a can that could not be processed conventionally.

For example, in a case in which the bottle can is manufactured by performing screw forming processing on the mouth portion, a plurality of different types of bottle can each having a different diameter of mouth portion can be manufactured by using only one can manufacturing apparatus.

Specifically, for example, in a case in which a bottle can having a diameter of 38 mm and a bottle can having a diameter of 28 mm that have the same outer diameter but have different diameters of mouth portion are subjected to screw forming processing by the same can manufacturing apparatus, the bottle cans can be manufactured as below.

That is, the second attachment hole of the processing table to which the screw forming processing tool (the large outer diameter rotational processing tool) is attached at the time of manufacturing the bottle can having a diameter of 38 mm does not need to be selected as the second attachment hole to which the screw forming processing tool is attached at the time of manufacturing the bottle can having a diameter of 28 mm. The second attachment hole to which the screw forming processing tool is attached at the time of manufacturing the bottle can having a diameter of 28 mm can be selected from the second attachment holes disposed on the processing procedure downstream side in the table circumferential direction in relation to the second attachment hole used to manufacture the bottle can having a diameter of 38 mm. Accordingly, the number of times of die processing (particularly, drawing processing) of the bottle can having a small diameter of 28 mm can be set to be larger than that of the bottle can having a diameter of 38 mm.

Thus, both bottle cans having different diameters can be satisfactorily manufactured.

In the description above, a case in which two types of bottle can, that is, the bottle can having a diameter of 38 mm and the bottle can having a diameter of 28 mm are manufactured by one can manufacturing apparatus has been described, but the type of diameter of the bottle can to be manufactured is not limited to two types. That is, in order to cope with, for example, a case in which bottle cans having three different types of diameter are manufactured by one can manufacturing apparatus, the number of second attachment holes provided in the processing table may be set to three. In order to cope with a case in which bottle cans having four different types of diameter are manufactured, the number of second attachment holes of the processing table may be set to four. The number of second attachment holes of the processing table may be set according to the desired diameter type of the bottle can.

According to the present invention, screw forming processing can be performed on the mouth portion and embossing processing can be performed on the neck portion, for example, at the time of manufacturing the long neck type bottle can.

In order to perform embossing processing on the neck portion of the can, the embossing tool (the large outer diameter rotational processing tool) is used. That is, in order to perform both screw forming processing and embossing processing on the can, the processing table needs to be provided with at least two large diameter rotational processing tools, that is, the screw forming processing tool for performing screw forming processing on the mouth portion and the embossing tool for performing embossing processing on the neck portion.

Here, in the present invention, the processing table is provided with at least two or more second attachment holes and (that is, at least two types or more of) the large outer diameter rotational processing tools can be provided according to the number of second attachment holes.

Accordingly, for example, the screw forming processing tool is attached to one second attachment hole among the plurality of second attachment holes provided in the processing table and the embossing tool can be attached to another second attachment hole located on the processing procedure downstream side in the table circumferential direction in relation to the second attachment hole. Screw forming processing is performed on the mouth portion of the can and then embossing processing can be performed on the neck portion.

The positional relationship between the screw forming processing tool and the embossing tool in the table circumferential direction of the processing table can be set to be opposite to the above-described positional relationship. In this case, embossing processing is performed on the neck portion by the embossing tool and then screw forming processing is performed on the mouth portion by the screw forming processing tool.

According to the present invention, for example, when there is demand for performing a plurality of types of embossing processing on the can body (the circumferential wall of the can) at the time of manufacturing a bottle can or an aerosol can, it is easy to cope with this demand.

That is, since the processing table is provided with at least two or more second attachment holes having a large inner diameter, (that is, at least two types or more of) the embossing tools (the large outer diameter rotational processing tools) can be attached according to the number of second attachment holes. Accordingly, it is possible to perform a plurality of types of embossing processing on the can.

As described above, according to the present invention, the large outer diameter rotational processing tool can be provided at a plurality of positions on the processing table. Accordingly, it is possible to perform various processes (particularly, processing using the rotational processing tool) on cans that could not be processed conventionally by, for example, manufacturing cans having different diameters using one can manufacturing apparatus, performing both screw forming processing and embossing processing on the can, or performing a plurality of types of embossing processing on the can.

The inventor of the present invention recognized the above-described problems and proposes a particular configuration in which at least two or more second attachment holes are provided in the processing table in order to exhibit excellent operational effects that can solve the problems. However, one skilled in the art who does not recognize the problems and the operational effects of the present invention should not unnecessarily increase the number of second attachment holes in the conventional processing table for the following reasons.

That is, since the second attachment hole is the attachment hole (the large inner diameter attachment hole) to which the large outer diameter rotational processing tool is attachable, there is a possibility that the arrangement pitch between the plurality of attachment holes arranged in the table circumferential direction may increase when the number of second attachment holes increases so that the size (the diameter) of the processing table increases. When the diameter of the processing table increases, the diameter of the holding table, of course, increases. When the sizes of the tables increase, the container capacity is limited at the time of transporting the table or the strength of the main body frame of the can manufacturing apparatus needs to be increased or the output of the driving system needs to be increased in accordance with an increase in weight of the table. Accordingly, there is a possibility that various expenses may increase.

Therefore, one skilled in the art who does not recognize the above-described problems and the excellent operational effects according to the present invention (that is, one who does not have motivation) could not have easily conceived of the present invention.

In the present invention, it is more desirable to set the number of second attachment holes provided in the processing table to two in order to keep the table size as small as possible while the above-described operational effects are exhibited.

In the processing table structure of the can manufacturing apparatus, at least one or more attachment holes other than the second attachment hole may be disposed between second attachment holes adjacent to each other in the table circumferential direction of the processing table.

For example, in a case in which a plurality of types of bottle can having different diameters are manufactured by one can manufacturing apparatus, when the second attachment holes are adjacently arranged without any attachment holes (the first attachment hole or the third attachment hole to be described later) other than the second attachment hole between the second attachment holes adjacent to each other in the table circumferential direction of the processing table differently from the above-described configuration, the following problems may occur.

That is, the second attachment hole to which the screw forming processing tool is attached at the time of manufacturing the bottle can having a large diameter and the second attachment hole (the second attachment hole disposed on the processing procedure downstream side) that is different from the above-described second attachment hole and to which the screw forming processing tool is attached at the time of manufacturing a bottle can having a small diameter are disposed in the table circumferential direction to be adjacent to each other (next to each other). For this reason, it is possible to increase the number of times of die processing (drawing processing) before screw forming processing by one instance at the time of manufacturing a bottle can having a small diameter compared to a case of manufacturing a bottle can having a large diameter. Thus, it is difficult to cope with a case of manufacturing a plurality of types of bottle can having greatly different diameters.

Here, it is desirable to dispose at least one or more attachment holes (attachment holes each having an inner diameter smaller than that of the second attachment hole) other than the second attachment hole between second attachment holes adjacent to each other in the table circumferential direction as in the processing table structure of the can manufacturing apparatus. Accordingly, it is possible to increase the number of times of die processing (particularly, drawing processing) before screw forming processing by two instances or more at the time of manufacturing a bottle can having a small diameter compared to a case of manufacturing a bottle can having a large diameter. Thus, it is easy to cope with a case of manufacturing a plurality of types of bottle can having greatly different diameters.

For example, in a case of manufacturing the long neck type bottle can in which screw forming processing is performed on the mouth portion and then embossing processing is performed on the neck portion, when the second attachment hole to which the screw forming processing tool (the large diameter rotational processing tool located on the processing procedure upstream side) is attached and another second attachment hole to which the embossing tool (the large diameter rotational processing tool located on the processing procedure downstream side) is attached are disposed adjacent to each other (next to each other) in the table circumferential direction without disposing any attachment hole other than the second attachment hole therebetween differently from the above-described configuration, there is a case in which the screw forming processing tool and the embossing tool interfere with each other so that either one of them may not be attachable to the processing table.

For example, in a case of manufacturing a bottle can or a aerosol can by performing various embossing processing on the can body, when the second attachment hole to which the embossing tool (the large diameter rotational processing tool located on the processing procedure upstream side) is attached and another second attachment hole to which another embossing tool (the large diameter rotational processing tool located on the processing procedure downstream side) performing embossing processing different from that of the embossing tool is attached are disposed adjacent to each other (next to each other) in the table circumferential direction without disposing any attachment hole other than the second attachment hole therebetween differently from the above-described configuration, there is a case in which the embossing tools interfere with each other so that either one of them may not be attached to the processing table.

For that reason, as in the processing table structure of the can manufacturing apparatus, it is desirable to dispose at least one or more attachment holes other than the second attachment hole between second attachment holes adjacent to each other in the table circumferential direction. Accordingly, since it is easy to prevent interference between the large outer diameter rotational processing tools attached to the second attachment holes that are adjacent to each other in the table circumferential direction (with a gap therebetween), it is possible to reliably attach a plurality of large diameter rotational processing tools to the processing table.

In the processing table structure of the can manufacturing apparatus, the plurality of attachment holes may be arranged at equal intervals in the table circumferential direction, the plurality of attachment holes may include a third attachment hole having an inner diameter smaller than that of the first attachment hole, and third attachment holes may be adjacently disposed respectively on both sides of the second attachment hole in the table circumferential direction.

In this case, the plurality of attachment holes arranged at equal intervals in the table circumferential direction of the processing table include the first attachment hole (the standard diameter hole), the second attachment hole (the large diameter hole) having an inner diameter larger than that of the first attachment hole, and the third attachment hole (the small diameter hole) having an inner diameter smaller than that of the first attachment hole. Third attachment holes (the small diameter holes) are respectively disposed adjacent to both sides of the second attachment hole (the large diameter hole) in the table circumferential direction.

Thus, it is possible to prevent a problem in which the attachment holes adjacent to each other in the table circumferential direction communicate with each other or are become extremely closer to each other while providing a plurality of second attachment holes each having a large inner diameter in the processing table and to stably attach the processing tools to the attachment holes. Further, it is possible to prevent an increase in size (diameter) of the processing table while providing a plurality of second attachment holes each having a large inner diameter in the processing table.

In the above-described configuration, it is desirable that the die processing tool and the small outer diameter rotational processing tool (the trimming processing tool, the curl processing tool, the throttle (curl caulking) processing tool, and the like) among the processing tools are attachable to the first attachment hole (the standard diameter hole) and the third attachment hole (the small diameter hole). As described above, the large outer diameter rotational processing tool (the screw forming processing tool, the embossing tool, and the like) is attachable to the second attachment hole (the large diameter hole).

In the processing table structure of the can manufacturing apparatus, the plurality of processing tools may include a die processing tool that performs die processing on a can while moving in a can axial direction and a rotational processing tool that performs rotational processing on a can while rotating around a can axis, at least a center/outer member type rotational processing tool may be provided as the rotational processing tool, the center/outer member type rotational processing tool including a center member that is disposed to face an inner peripheral surface of a circumferential wall of a can and an outer member disposed to face an outer peripheral surface of the circumferential wall of the can and giving a predetermined shape to the circumferential wall by sandwiching the circumferential wall of the can while moving the center member and the outer member closer to each other, and the center/outer member type rotational processing tool may be attachable to the second attachment hole.

In the processing table structure of the can manufacturing apparatus with the above-described configuration, a plurality of processing tools are attached to the plurality of attachment holes arranged in the table circumferential direction of the processing table and the processing tools include the die processing tool and the rotational processing tool.

As the rotational processing tool, at least the center/outer member type rotational processing tool is provided. Since the center/outer member type rotational processing tool has an outer diameter larger than the outer diameter of the other rotational processing tools due to its structure, the rotational processing tool can be attached only to the second attachment hole among the plurality of attachment holes.

The center/outer member type rotational processing tool includes the center member that is inserted into the can and is disposed to face the inner peripheral surface of the circumferential wall of the can when the holding table and the processing table move closer to each other in the table axial direction and the outer member that is disposed to face the outer peripheral surface of the circumferential wall of the can. By using, for example, a cam roller mechanism or the like operated (moved in synchronization) in accordance with the approaching movement of the holding table and the processing table, the center member and the outer member are moved closer to each other to sandwich the circumferential wall of the can therebetween. Accordingly, the circumferential wall of the can has a predetermined shape imparted thereto.

Specifically, for example, in a state where the center member and the outer member sandwich the circumferential wall of the can, the center/outer member type rotational processing tool is rotated around the processing tool axis (the rotation center axis of the tool spindle) with respect to the processing table. By using a gear mechanism operated according to the rotation, the center member and the outer member are rotated (revolved) around the can axis while reversely rotating (spinning) around respective axes thereof in synchronization and sandwiching the circumferential wall of the can therebetween so that both members roll on the circumferential wall. Accordingly, the circumferential wall of the can is formed in a predetermined shape by performing screw forming processing on the entire periphery of the circumferential wall or embossing processing on at least a part of the circumferential wall. That is, the screw forming processing tool or the embossing tool can be used as the center/outer member type rotational processing tool.

As described above, the processing table is provided with at least two or more second attachment holes. That is, at least two or more center/outer member type rotational processing tools can be attached to the processing table.

Thus, it is possible to manufacture cans having different diameters with one can manufacturing apparatus or increase the number of processing variations for cans by attaching (that is, at least two types or more of) the center/outer member type rotational processing tool to the processing table according to the number of second attachment holes.

In the processing table structure of the can manufacturing apparatus, a screw forming processing tool may be provided as the center/outer member type rotational processing tool.

In the processing table structure of the can manufacturing apparatus, an embossing tool may be provided as the center/outer member type rotational processing tool.

### Advantageous Effects of Invention

According to the spindle rotation unit of an aspect of the present invention, the driving motor for rotating the spindle can be easily disposed to correspond to the spindle even when the arrangement position of the spindle attached to one of a plurality of attachment portions arranged in the base is changed.

According to the processing table structure of the can manufacturing apparatus of another aspect of the present invention, it is possible to perform various processes on cans that could not be processed conventionally by providing a plurality of large outer diameter rotational processing tools in the processing table to manufacture, for example, a plurality of types of cans having different diameters with one can manufacturing apparatus, to perform both screw forming processing and embossing processing on the can, or to perform a plurality of types of embossing processing on the can.

### BRIEF DESCRIPTION OF THE DRAWINGS

FIG. 1 is an exploded perspective view showing a rotational processing tool driving structure of a can manufacturing apparatus according to an embodiment of a spindle rotation unit of the present invention.

FIG. 2 is a plan view showing a processing table (a base).

FIG. 3 is a plan view showing a motor plate.

FIG. 4A is a plan view showing a motor attachment flange and FIG. 4B is a diagram showing a cross-section taken along a line B-B of FIG. 4A.

FIG. 5 is a plan view of the rotational processing tool driving structure of the can manufacturing apparatus when viewed in a table axis direction.

FIG. 6 is a plan view showing an example in which an attachment position of a rotational processing tool (a spindle) is changed in the rotational processing tool driving structure of the can manufacturing apparatus.

FIG. 7 is a plan view showing an example in which the attachment position of the rotational processing tool (the spindle) is changed in the rotational processing tool driving structure of the can manufacturing apparatus.

FIG. 8 is a plan view showing an example in which the attachment position of the rotational processing tool (the spindle) is changed in the rotational processing tool driving structure of the can manufacturing apparatus.

FIG. 9 is a plan view showing an example in which the attachment position of the rotational processing tool (the spindle) is changed in the rotational processing tool driving structure of the can manufacturing apparatus.

FIG. 10 is a perspective view showing a processing table used in the embodiment of the processing table structure of the can manufacturing apparatus of the present invention.

FIG. 11 is a perspective view showing the processing table.

FIG. 12 is a plan view showing a main part of a processing table structure of a can manufacturing apparatus according to a first embodiment of the processing table structure of the can manufacturing apparatus of the present invention.

FIG. 13 is a plan view showing a main part of a modified example of the processing table structure of the can manufacturing apparatus according to the first embodiment of the processing table structure of the can manufacturing apparatus of the present invention.

FIG. 14 is a longitudinal sectional view showing an embossing tool of a processing table structure of a can manufacturing apparatus according to a second embodiment of the processing table structure of the can manufacturing apparatus of the present invention.

FIG. 15 is a longitudinal sectional view showing a modified example of the embossing tool of the second embodiment of the processing table structure of the can manufacturing apparatus of the present invention.

### DETAILED DESCRIPTION OF THE INVENTION

Hereinafter, an embodiment of a can manufacturing apparatus 11 of the present invention and a rotational processing tool driving structure (a spindle rotation unit) 110 thereof will be described with reference to the drawings.

The can manufacturing apparatus 11 of the embodiment is a so-called bottle necker that manufactures a bottle can having a desired shape by performing various bottle necking processings including die processing and rotational processing on a bottomed cylinder can.

A can that is supplied as a workpiece to the can manufacturing apparatus 11 is a DI can that has been subjected to drawing and ironing (DI) processing in a previous step. The DI can is formed in a bottomed cylindrical shape by applying a capping step (a drawing step), a drawing and ironing step (DI) step, and the like to a disk-shaped blank punched out from a plate material of an aluminum alloy material. The bottle can manufactured by the can manufacturing apparatus 11 is filled with contents such as a beverage in a later step and a cap is screwed thereonto.

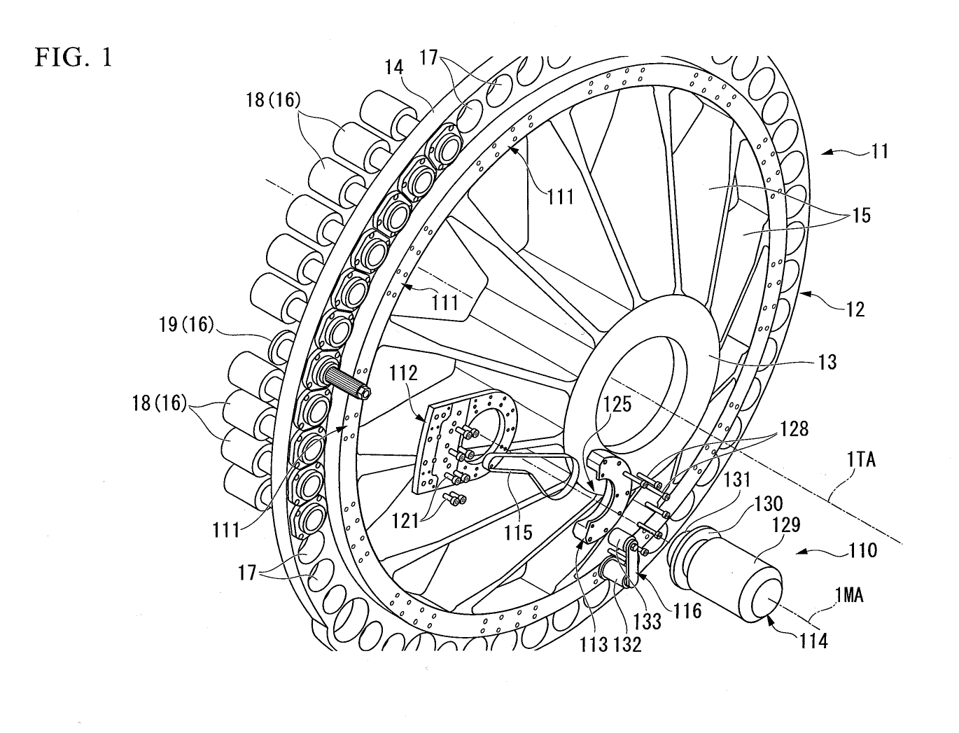

In FIG. 1, the can manufacturing apparatus 11 includes a processing table 12 and a holding table (not shown) that are disposed to face each other. The center axes (table axes 1TA) of the processing table 12 and the holding table extend in a horizontal direction and the center axes are coaxially disposed.

In the embodiment, a direction in which the table axis 1TA (an extension direction of the table axis 1TA) is aligned will be referred to as the direction of the table axis 1TA.

A direction orthogonal to the table axis 1TA will be referred to as a table radial direction. In the table radial direction, a direction of moving away from the table axis 1TA will be referred to as outward in the table radial direction and a direction of moving closer to the table axis 1TA will be referred to as inward in the table radial direction.

A direction around the table axis 1TA will be referred to as a table circumferential direction.

A direction in which a motor axis 1MA of a driving motor 114 to be described later (an extension direction of the motor axis 1MA) is aligned will be referred to as a direction of the motor axis 1MA. In an example of the embodiment, the table axis 1TA and the motor axis 1MA are parallel to each other.

A direction orthogonal to the motor axis 1MA will be referred to as a motor radial direction. In the motor radial direction, a direction of moving away from the motor axis 1MA will be referred to as outward in the motor radial direction and a direction of moving closer to the motor axis 1MA will be referred to as inward in the motor radial direction.

A direction around the motor axis 1MA will be referred to as a motor circumferential direction.

The can manufacturing apparatus 11 includes a main body frame that supports the processing table 12 and the holding table. The main body frame is provided with a table driving unit and the table driving unit includes a table driving motor, a connection shaft, and a crank mechanism.

The processing table 12 and the holding table are repeatedly moved closer to and away from the direction of the table axis 1TA and are intermittently and relatively rotated in the table circumferential direction by the table driving unit of the main body frame. Specifically, the processing table 12 is moved closer to and away from the direction of the table axis 1TA with respect to the holding table and the holding table is rotated by a predetermined amount in the table circumferential direction with respect to the processing table 12 during one approaching/separating stroke (reciprocating movement).

Every stroke in which the processing table 12 and the holding table move closer to and away from each other, a can held by the holding table is processed by a processing tool 16 provided in the processing table 12 and the holding table moves the can to a processing position of the next (different) processing tool 16.

When this operation is repeated, the can held by the holding table is sequentially processed by the processing tools 16 provided in the processing table 12 and a bottle can having a desired shape has been manufactured at a time point at which a processing series ends.

The holding table is generally called a turntable. Although not shown particularly in the drawings, the holding table is formed in a disk shape or a circular ring shape. A plurality of chucks (can holders) are arranged in the table circumferential direction on an outer peripheral surface of a portion facing the processing table 12 in the holding table. Cans are respectively held by the chucks and opening end portions of the held cans are open toward the processing table 12.

For the configurations of the holding table and the main body frame of the can manufacturing apparatus 11 of the embodiment, for example, known configurations disclosed in Japanese Unexamined Patent Application, First Publication No. 2005-329424 can be used.

The processing table 12 is generally called a die table. The processing table 12 corresponds to a base of the present invention. Specifically, a base of the embodiment is a table and the processing table 12 is used as an example of the table.

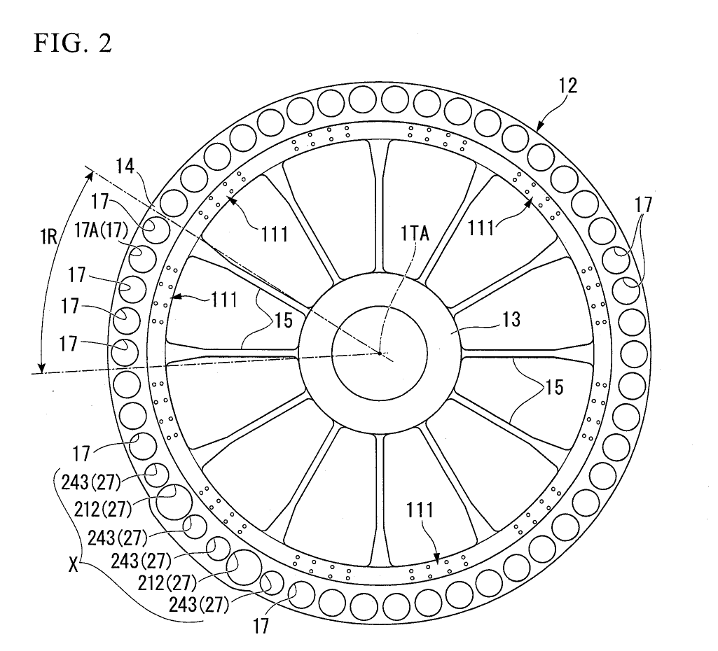

In FIGS. 1 and 2, the processing table 12 is formed in a disk shape or a circular ring shape. In this embodiment, the processing table 12 is formed in a double ring shape.

Specifically, the processing table 12 includes an inner ring body 13 that is connected to a connection shaft of the main body frame, an outer ring body 14 that is disposed outward in the table radial direction of the inner ring body 13 and is coaxial therewith, and a plurality of ribs 15 that connect the ring bodies 13 and 14 in the table radial direction and are disposed at intervals in the table circumferential direction.

In the example shown in the drawings, twelve ribs 15 are arranged at equal intervals in the table circumferential direction between the inner ring body 13 and the outer ring body 14 and the number of gaps (spaces) formed between the ribs 15 adjacent to each other in the table circumferential direction is also twelve.

In the processing table 12 of the embodiment, a wide space is secured between the ribs 15 adjacent to each other in the table circumferential direction and a motor plate 112 to be described later is disposed in this space.

In the embodiment, the length of the inner ring body 13 in the direction of the table axis 1TA is set to be larger than the length of the outer ring body 14 in the direction of the table axis 1TA. Accordingly, the length of the rib 15 in the direction of the table axis 1TA is also formed to gradually increase from a portion connected to the outer ring body 14 inward in the table radial direction and becomes maximum at a portion connected to the inner ring body 13.

The thickness of the rib 15 (the size in the table circumferential direction) becomes maximum at a portion connected to the outer ring body 14 in an outer end portion of the rib 15 in the table radial direction and gradually decreases inward in the table radial direction from this portion. In a portion other than the outer end portion of the rib 15 in the table radial direction, the thickness of the rib 15 becomes substantially uniform in the table radial direction.

In the processing table 12, the processing tools 16 that process the can held by the holding table are arranged in the table circumferential direction. These processing tools 16 are arranged in the table circumferential direction on an outer circumferential portion of a surface facing the holding table in the processing table 12 and are disposed to respectively face the plurality of cans held by the holding table from the direction of the table axis 1TA. In FIG. 1, only a part of the plurality of processing tools 16 arranged in the processing table 12 are shown.

Specifically, a plurality of attachment holes (attachment portions) 17 are formed and arranged in the table circumferential direction to penetrate the processing table 12 in the direction of the table axis 1TA and the plurality of processing tools 16 are attachable to the attachment holes 17 according to a can processing procedure.

The attachment hole 17 opens to an outer circumferential portion of a surface facing the holding table in the processing table 12 and is formed to penetrate a surface facing the side opposite to the holding table in the outer peripheral portion. In the embodiment, the plurality of attachment holes 17 are formed in the outer ring body 14 and are arranged in the table circumferential direction. In the example shown in the drawings, the plurality of attachment holes 17 are arranged along the entire periphery of the processing table 12 in the table circumferential direction and the number of attachment holes 17 formed in the processing table 12 is fifty.

The plurality of processing tools 16 include a die processing tool 18 and a rotational processing tool 19. The die processing tool 18 moves in the can axial direction (a direction parallel to the table axis 1TA) with respect to the can and performs die processing such as drawing processing for decreasing the diameter of the circumferential wall of the can or expanding processing for increasing the diameter of the circumferential wall. One die processing tool 18 performs one type of die processing on the can.

The die processing tool 18 includes a mold that performs die processing on the can and a mold holder that is separably attached to the attachment hole 17 and holds the mold. In FIG. 1, the mold holder of the die processing tool 18 is shown.

The rotational processing tool 19 rotates about the can axis with respect to the can and performs rotational processing such as trimming processing, screw forming processing, curling processing, and throttle (curl caulking) processing on the circumferential wall of the can with the rotation about the can axis. One rotational processing tool 19 performs one type of rotational processing on the can.

The rotational processing tool 19 includes a molding portion that performs rotational processing on the can and a tool spindle (a spindle) that is separably attached to the attachment hole 17 and supports the molding portion so that the molding portion rotates about its center axis (the center axis of the rotational processing tool 19) with respect to the attachment hole 17. The tool spindle includes a plate portion that is attached to the attachment hole 17 and a spindle shaft portion that is formed to penetrate the plate portion to be rotatable about the center axis of the rotational processing tool 19 and is connected to the molding portion. In FIG. 1, the tool spindle of the rotational processing tool 19 is shown.

The tool spindle is attached to any one of the plurality of attachment holes 7 arranged in the processing table 12 to be rotatable about the spindle center axis (the center axis of the attachment hole 17).

In FIGS. 1 and 2, a plate attachment hole group (a plate attachment portion) 111 is formed in a portion corresponding to a space between adjacent ribs 15 in the table circumferential direction in the outer ring body 14 of the processing table 12. In this embodiment, the plate attachment hole group 111 includes eight female screw holes and these female screw holes open to a surface facing the side opposite to the holding table in the processing table 12 and extend in the direction of the table axis 1TA.

A plurality of plate attachment hole groups 111 are formed in the processing table 12 at intervals in the table circumferential direction and in the example shown in the drawings, the plate attachment hole groups are formed at twelve positions at equal intervals in the table circumferential direction.

Reference numeral 1R shown in FIG. 2 denotes a predetermined region of the processing table 12 in the table circumferential direction. In the example shown in the drawings, the predetermined region 1R is set to a surface facing the side opposite to the holding table in the processing table 12. The predetermined region 1R is a circular-arc region having a predetermined length in the table circumferential direction of the outer ring body 14 of the processing table 12. In this embodiment, a plurality of attachment holes 17 including a pair of attachment holes 17 located outward in the table radial direction of a pair of ribs 15 adjacent to each other in the table circumferential direction are disposed in the predetermined region 1R of the processing table 12. In the example shown in the drawings, five attachment holes 17 are included in the predetermined region 1R.

The plate attachment hole group 111 is disposed in a portion located inward in the table radial direction of the plurality of attachment holes 17 in the predetermined region 1R. In this embodiment, the predetermined region 1R of the processing table 12 corresponds to a plurality of plate attachment hole groups 111 arranged in the table circumferential direction and is provided at a plurality of positions over the entire periphery in the table circumferential direction. The predetermined region 1R of the embodiment is provided at twelve positions at equal intervals without gaps in the table circumferential direction.

The attachment hole 17 disposed at the end portion in the table circumferential direction of each predetermined region 1R (a portion in which predetermined regions 1R are adjacent to each other) in a pair of adjacent predetermined regions 1R in the table circumferential direction may be included in both of the pair of predetermined regions 1R or may be included only in either one of the predetermined regions 1R. Any attachment hole 17 is included in at least any one of the plurality of predetermined regions 1R arranged in the table circumferential direction. That is, in the embodiment, all attachment holes 17 are disposed in the predetermined regions 1R.

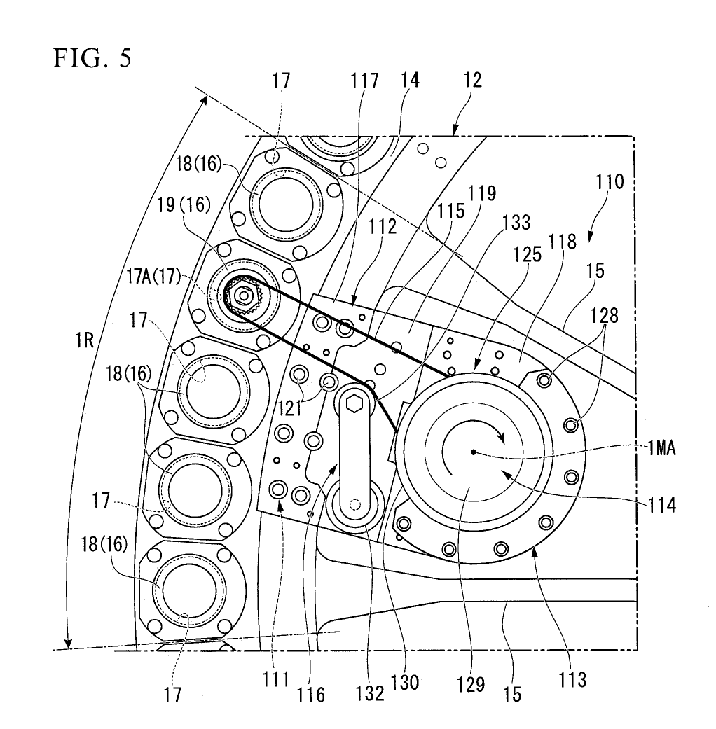

As shown in FIGS. 2 and 5, the rotational processing tool 19 is attached to any attachment hole 17 (which is, for example, one attachment hole 17 and hereinafter will be referred to as a predetermined attachment hole 17A) among the plurality of attachment holes 17 included in one predetermined region 1R. The die processing tool 18 that is a non-rotational processing tool is attached to attachment holes 17 other than the predetermined attachment hole 17A among the plurality of attachment holes 17 included in one predetermined region 1R. Some of the plurality of attachment holes 17 may be empty spaces to which the processing tools 16 are not attached.

As shown in FIGS. 1 and 5, the rotational processing tool driving structure (the spindle rotation unit) 110 of the can manufacturing apparatus 11 of the embodiment includes a motor plate 112 that is attached to each processing table 12 (specifically, the motor plate is attached to a position corresponding to the predetermined region 1R of the processing table 12) that is a base, a motor attachment flange 113 that is attached to the motor plate 112, a driving motor 114 that is attached to the motor attachment flange 113, a transfer member 115 that connects the driving motor 114 to a spindle (a tool spindle of the rotational processing tool 9) and transfers a rotational driving force of the driving motor 114 to the spindle (the tool spindle of the rotational processing tool 19), and a belt tensioner 116 that is attached to the motor plate 112 to maintain a tensile force (a tension load or a tension) of the transfer member 115 at or above a predetermined value.

In FIGS. 1, 3, and 5, the motor plate 112 is formed in a plate shape. As shown in FIG. 5, the motor plate 112 is disposed to extend in the table radial direction while the motor plate 112 is attached to the processing table 12. In the example shown in the drawings, the motor plate 112 is disposed to extend from a position corresponding to the inner peripheral edge of the outer ring body 14 inward in the table radial direction to a position corresponding to an outer portion of the rib 15 in the table radial direction.

The length (width) of the motor plate 112 in the table circumferential direction is set to be smaller than a distance between the pair of adjacent ribs 15 in the table circumferential direction in the predetermined region 1R of the processing table 12. Specifically, the width of the motor plate 112 in the table circumferential direction is set to be smaller than the distance in the table circumferential direction between the ribs 15 adjacent to each other in the table circumferential direction in a portion corresponding to the outer portion of the ribs 15 in the table radial direction in the predetermined region 1R. Accordingly, the motor plate 112 is disposed in a space between the ribs 15.

The motor plate 112 is attached to the processing table 12 while in contact with a surface facing the side opposite to the holding table in the outer ring body 14 in the direction of the table axis 1TA.

The outer end portion of the motor plate 112 in the table radial direction protrudes by the plate thickness toward the side opposite to the holding table in the direction of the table axis 1TA in relation to the outer ends of adjacent ribs 15 in the table circumferential direction of the motor plate 112.

A portion other than the outer end portions of adjacent ribs 15 in the table circumferential direction of the motor plate 112 protrudes toward the side opposite to the holding table in the direction of the table axis 1TA in relation to a portion (a portion including at least the inner end portion) other than the outer end portion of the motor plate 112 in the table radial direction. In other words, a portion other than the outer end portions of the motor plate 112 in the table radial direction is received in the space between the pair of adjacent ribs 15 at both sides of the motor plate 112 in the table circumferential direction so as not to protrude from the ribs 15 in the direction of the table axis 1TA.

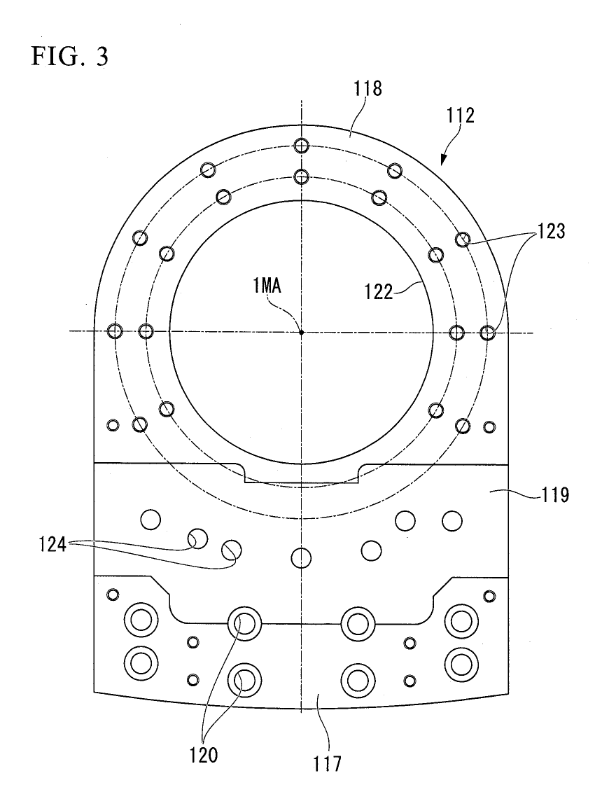

As shown in FIGS. 3 and 5, the motor plate 112 is formed in a plate shape in which a square shape and a semi-circular shape are arranged in the table radial direction of the processing table 12 in a plan view in which the motor plate 112 is viewed in the thickness direction (corresponding to a plan view in which the processing table 12 is viewed in the direction of the table axis 1TA).

The motor plate 112 includes a table connection portion 117 that is attached to the processing table 12, a motor connection portion 118 to which the motor attachment flange 113 is attached and which supports the driving motor 114 through the motor attachment flange 113, and a tensioner connection portion 119 that is located between the table connection portion 117 and the motor connection portion 118 and in which the belt tensioner 116 is disposed.

In the motor plate 112, the table connection portion 117, the tensioner connection portion 119, and the motor connection portion 118 are disposed in this order inward in the table radial direction.

In FIG. 3, a plurality of bolt insertion holes 120 are formed at positions corresponding to the plurality of female screw holes of the plate attachment hole group 111 formed in the predetermined region 1R of the processing table 12 in the table connection portion 117. These bolt insertion holes 120 are formed to penetrate the motor plate 112 in the thickness direction (a direction parallel to the direction of the table axis 1TA and the direction of the motor axis 1MA of the driving motor 114). In the example shown in the drawings, the bolt insertion holes correspond to eight female screw holes of the plate attachment hole group 111 and eight bolt insertion holes 120 are formed in the table connection portion 117.

A bolt denoted by reference numeral 121 in FIGS. 1 and 5 is inserted through the bolt insertion hole 120 and the bolt 121 is threaded into the female screw hole of the plate attachment hole group 111.

As shown in FIG. 3, the motor connection portion 118 includes a round hole 122 that is formed to penetrate the motor plate 112 in the thickness direction and is disposed to be coaxial with the motor axis 1MA of the driving motor 114 and a plurality of female screw holes 123 that are arranged at intervals around the center axis of the round hole 122 (in the motor circumferential direction) and are formed to penetrate the motor plate 112 in the thickness direction. In FIG. 3, the center axis of the round hole 122 is denoted by reference numeral 1MA similarly to the motor axis 1MA.

A plurality of tensioner attachment holes 124 for attaching the belt tensioner 116 to the motor plate 112 are formed in the tensioner connection portion 119 to penetrate the motor plate 112 in the thickness direction.

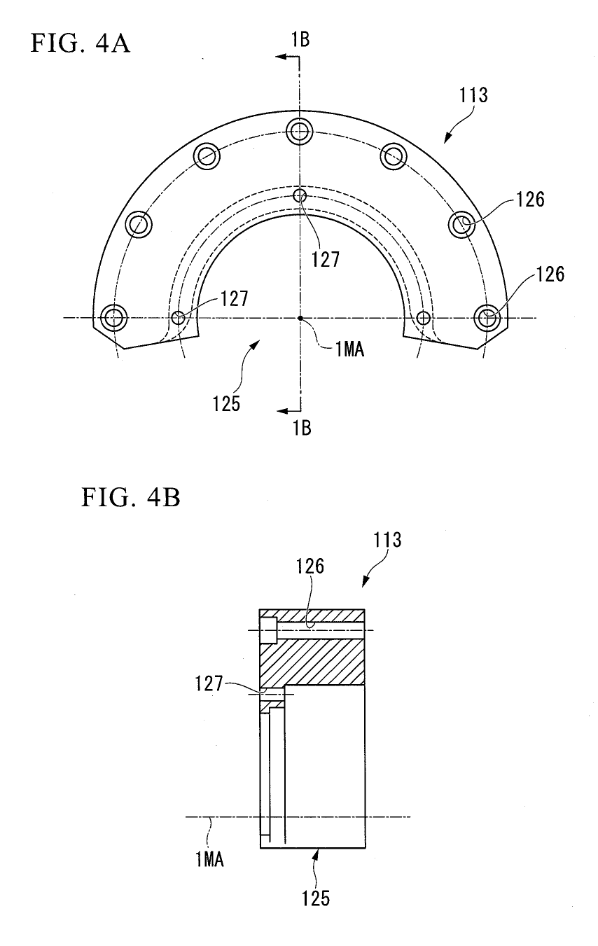

In FIGS. 1, 4, and 5, the motor attachment flange 113 is formed in an annular plate shape that is partially notched in the circumferential direction. As shown in FIGS. 4A and 5, the motor attachment flange 113 is formed in a circular-arc shape (that is, substantially a C-shape) in which a part of a circle is removed and is open in a plan view in which the motor attachment flange 113 is viewed in the thickness direction (a direction parallel to the direction of the table axis 1TA and the direction of the motor axis 1MA).

The center axis of the motor attachment flange 113 is coaxial with the motor axis 1MA of the driving motor 114 attached to the motor attachment flange 113 and in FIGS. 4A and 4B, the center axis of the motor attachment flange 113 is denoted by reference numeral 1MA similar to the motor axis 1MA.

The motor attachment flange 113 is formed to extend in a region of at least 180° or more around the center axis 1MA (in the motor circumferential direction). An opening portion 125 through which the transfer member 115 is inserted is formed between both end portions of the motor attachment flange 113 around the center axis 1MA. The opening portion 125 is formed to be open between both end portions of the motor attachment flange 113 around the center axis 1MA so that the inside and the outside in the radial direction (the motor radial direction) orthogonal to the center axis 1MA in the motor attachment flange 113 communicate with each other.

The motor attachment flange 113 includes a plurality of bolt insertion holes 126 that are formed to penetrate the motor attachment flange 113 in the thickness direction and are arranged at intervals around the center axis 1MA (in the motor circumferential direction) and a plurality of female screw holes 127 that are disposed inward in the radial direction (the motor radial direction) orthogonal to the center axis 1MA in relation to the bolt insertion holes 126 to penetrate the motor attachment flange 113 in the thickness direction and to be arranged at intervals around the center axis 1MA.

In the example shown in FIG. 4A, the female screw holes 127 are disposed at both end portions of the motor attachment flange 113 around the center axis 1MA and an intermediate portion located between both end portions.

A bolt denoted by reference numeral 128 in FIGS. 1 and 5 is inserted through the bolt insertion hole 126 and the bolt 128 is threaded into the female screw hole 123 of the motor plate 112. Accordingly, as shown in FIG. 5, the motor attachment flange 113 is fixed to the motor plate 112.

In FIG. 5, the motor attachment flange 113 is disposed in the motor plate 112 to allow its position to be adjustable so that the opening portion 125 is open toward the predetermined attachment hole 17A in which the spindle (the tool spindle of the rotational processing tool 19) is attached among the plurality of attachment holes 17 of the processing table 12 (included in the predetermined region 1R).

Specifically, since the motor attachment flange 113 is attached to the motor plate 112 to be rotatable around the motor axis 1MA of the driving motor 114, the motor attachment flange is disposed so that its position can be adjusted.

The “position adjustment” will be described in detail.

In order to adjust the position of the motor attachment flange 113 with respect to the motor plate 112, the threading of the bolt 128 into the female screw hole 123 of the motor plate 112 is released so that the motor attachment flange 113 is rotatable around the motor axis 1MA with respect to the motor plate 112.

Next, the position is adjusted while the motor attachment flange 113 is rotated around the motor axis 1MA with respect to the motor plate 112 so that the opening portion 125 of the motor attachment flange 113 faces (the tool spindle of) the rotational processing tool 19 attached to the predetermined attachment hole 17A. Specifically, the rotation position of the motor attachment flange 113 around the motor axis 1MA with respect to the motor plate 112 is adjusted so that an intermediate portion located between both end portions around the motor axis 1MA in the opening portion 125 is disposed on an imaginary line connecting the motor axis 1MA and the rotation axis (the center axis of the tool spindle) of the rotational processing tool 19 in the plan view shown in FIG. 5. At this time, the positions are aligned so that the female screw hole 123 of the motor plate 112 and the bolt insertion hole 126 of the motor attachment flange 113 communicate with each other.

With the position adjustment, the opening portion 125 of the motor attachment flange 113 becomes open toward the rotational processing tool 19 and the predetermined attachment hole 17A.

Next, the bolt 128 inserted through the bolt insertion hole 126 is threaded into the female screw hole 123 again. Accordingly, the rotation of the motor attachment flange 113 around the motor axis 1MA with respect to the motor plate 112 is restricted and the motor attachment flange 113 is fixed to the motor plate 112.

As shown in FIG. 1, the driving motor 114 includes a motor body 129, an annular flange 130 that protrudes from the motor body 129 outward in the motor radial direction and extends over the entire periphery in the motor circumferential direction, a shaft portion (not shown) that protrudes from the motor body 129 in the direction of the motor axis 1MA and rotates in the motor circumferential direction with respect to the motor body 129, and a motor pulley 131 that is attached to the shaft portion.

An arrow around the motor axis 1MA shown in FIG. 5 indicates the rotation directions of the shaft portion and the motor pulley 131 with respect to the motor body 129.

The flange 130 is in contact with a region of at least 180° or more in the motor circumferential direction of the motor attachment flange 113. The driving motor 114 is supported by the motor attachment flange 113 in a region of at least 180° or more in the motor circumferential direction.

The flange 130 is provided with a plurality of holes that are formed to penetrate the flange 130 in the thickness direction and are arranged at intervals in the motor circumferential direction. Although not particularly shown in the drawings, bolts are inserted through these holes and the bolts are threaded into the female screw holes 127 of the motor attachment flange 113. Accordingly, the driving motor 114 is fixed to the motor attachment flange 113.

In a state where the driving motor 114 is attached to the motor attachment flange 113, the motor pulley 131 is disposed inward from the motor attachment flange 113.

As shown in FIGS. 1 and 5, in the embodiment, the transfer member 115 is an annular belt. As the transfer member 115, for example, a timing belt or the like can be used. The transfer member 115 is wound (wrapped) around the motor pulley 131 of the driving motor 114 and the tool spindle of the rotational processing tool 19 and can transfer the rotational driving force of the driving motor 114 to the rotational processing tool 19. The transfer member 115 is inserted through the opening portion 125 of the motor attachment flange 113.

In FIGS. 1 and 5, the belt tensioner 116 includes a main body 132 that is attached to the motor plate 112 and a contact portion 133 that is brought into contact with the transfer member 115.

Although particularly not shown in the drawings, a female screw hole opens to an end surface facing the motor plate 112 in the main body 132. A bolt inserted through a predetermined tensioner attachment hole 124 among the plurality of tensioner attachment holes 124 of the motor plate 112 is threaded into the female screw hole of the main body 132. Accordingly, the belt tensioner 116 is fixed to the motor plate 112.

The contact portion 133 is brought into contact with a movement region from the motor pulley 131 of the driving motor 114 to the tool spindle of the rotational processing tool 19 in the transfer member 115. Specifically, in the plan view shown in FIG. 5, the rotation direction of the motor pulley 131 is a clockwise rotation direction and the contact portion 133 of the belt tensioner 116 is in contact with a supply side region from the driving motor 114 to the rotational processing tool 19 in the transfer member 115 and presses (applies a tension to) the transfer member 115 so that the transfer member does not slacken. In the example shown in the drawings, the contact portion 133 is of a pressing roller type, but the present invention is not limited thereto.

The belt tensioner 116 is disposed in the motor plate 112 to allow its position to be adjustable in response to the predetermined attachment hole 17A to which the spindle (the tool spindle of the rotational processing tool 19) is attached among the plurality of attachment holes 17 (included in the predetermined region 1R) of the processing table 12.

The position of the transfer member 115 wound on the rotational processing tool 19 also changes depending on the rotational processing tool 19 attached to a certain attachment hole 17 among the plurality of attachment holes 17 disposed in the predetermined region 1R. For this reason, the attachment position of the belt tensioner 116 in the motor plate 112 is adjustable in accordance with the position of the predetermined attachment hole 17A to which the rotational processing tool 19 is attached and a change in position of the transfer member 115.

In the above-described rotational processing tool driving structure (the spindle rotation unit) 110 of the can manufacturing apparatus 11 of the embodiment, the plurality of attachment holes 17 are arranged in the processing table 12 that is a base. The spindle (the tool spindle of the rotational processing tool 19) is rotatably attached to one attachment hole 17 among the plurality of attachment holes 17. The motor plate 112 is attached to the processing table 12.

Specifically, the motor plate 112 is attached to correspond to the predetermined region 1R in the table circumferential direction of the processing table 12. Specifically, one motor plate 112 is attached to the plate attachment hole group 111 of one predetermined region 1R. The plurality of attachment holes 17 to which the processing tools 16 are attached are arranged in the predetermined region 1R. The rotational processing tool 19 is attached to the predetermined attachment hole 17A among the attachment holes 17 and the die processing tool 18 is attached to attachment holes 17 other than the predetermined attachment hole 17A.

The motor attachment flange 113 is attached to the motor plate 112 and the driving motor 114 is attached to the motor attachment flange 113. That is, the driving motor 114 is disposed in the processing table 12 via the motor attachment flange 113 and the motor plate 112.

The driving motor 114 and the spindle (the tool spindle of the rotational processing tool 19) are connected to each other through the transfer member 115 inserted through the opening portion 125 of the motor attachment flange 113.

According to the embodiment, the motor attachment flange 113 can be attached to the motor plate 112 while its position is adjusted so that the opening portion 125 of the motor attachment flange 113 becomes open toward the predetermined attachment hole 17A to which (the tool spindle of) the rotational processing tool 19 is attached among the plurality of attachment holes 17 arranged in (the predetermined region 1R of) the processing table 12.

Thus, since the opening portion 125 of the motor attachment flange 113 can become reliably open toward the rotational processing tool 19 irrespective of which attachment hole 17 among the plurality of attachment holes 17 (included in the predetermined region R) of the processing table 12 to which the rotational processing tool 19 is attached, the transfer member 115 can be reliably inserted through the opening portion 125.

The rotational driving force of the driving motor 114 can be stably transferred to the rotational processing tool 19 by the transfer member 115 without any interference between the motor attachment flange 113 and the transfer member 115 inserted through the opening portion 125 of the motor attachment flange 113 regardless of the attachment position of the rotational processing tool 19 of (the predetermined region 1R of) the processing table 12.

For this reason, the predetermined attachment hole 17A in which the rotational processing tool 19 of (the predetermined region 1R of) the processing table 12 is disposed can be freely selected from the plurality of attachment holes 17. The die processing tool 18 can be appropriately disposed in attachment holes 17 other than the predetermined attachment hole 17A.

Specifically, in the embodiment, as shown in FIG. 5, the attachment hole 17 that is disposed next to the attachment hole 17 disposed at the end portion on one side (the upper side in FIG. 5) in the table circumferential direction toward the other side (the lower side in FIG. 5) among five attachment holes 17 included the predetermined region 1R of the processing table 12 is set as the predetermined attachment hole 17A. The motor attachment flange 113 is fixed to the motor plate 112 while its position is adjusted so that (the tool spindle of) the rotational processing tool 19 is disposed in the predetermined attachment hole 17A and the opening portion 125 is open toward the rotational processing tool 19.

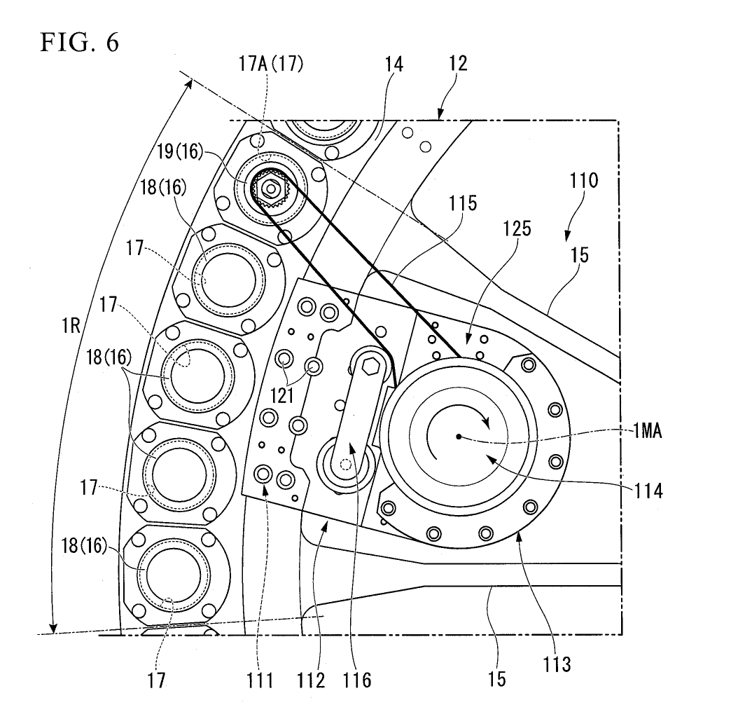

Here, FIGS. 6 to 9 show a modified example of the embodiment and the position of the predetermined attachment hole 17A to which the rotational processing tool 19 is attached among the plurality of attachment holes 17 in the predetermined region 1R is different from the position of the predetermined attachment hole 17A shown in FIG. 5.

In the modified example shown in FIG. 6, the attachment hole 17 disposed at one end portion in the table circumferential direction (the upper side in FIG. 6) among five attachment holes 17 included in the predetermined region 1R is set as the predetermined attachment hole 17A. The motor attachment flange 113 is fixed to the motor plate 112 while its position is adjusted so that (the tool spindle of) the rotational processing tool 19 is disposed in the predetermined attachment hole 17A and the opening portion 125 is open toward the rotational processing tool 19.

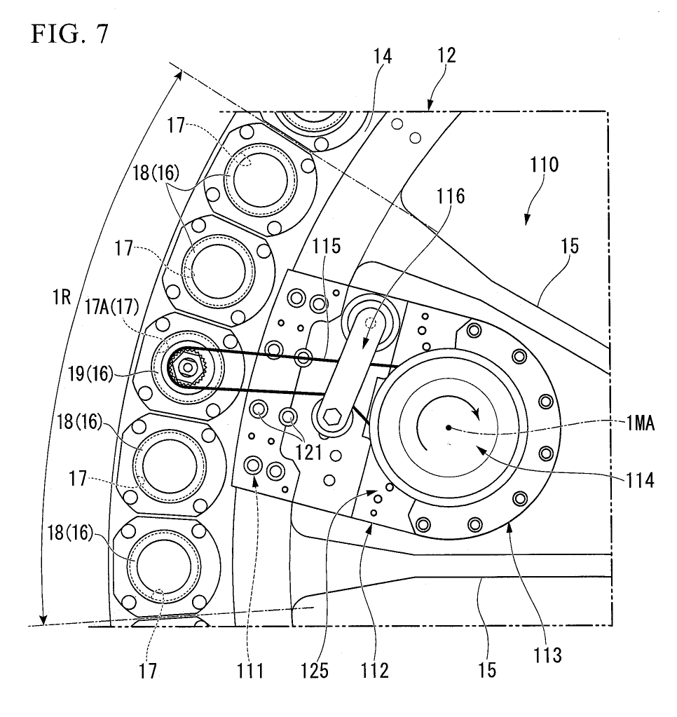

In the modified example shown in FIG. 7, the attachment hole 17 located at the center portion in the table circumferential direction among five attachment holes 17 included in the predetermined region 1R is set as the predetermined attachment hole 17A. The motor attachment flange 113 is fixed to the motor plate 112 while its position is adjusted so that (the tool spindle of) the rotational processing tool 19 is disposed in the predetermined attachment hole 17A and the opening portion 125 is opened toward the rotational processing tool 19.

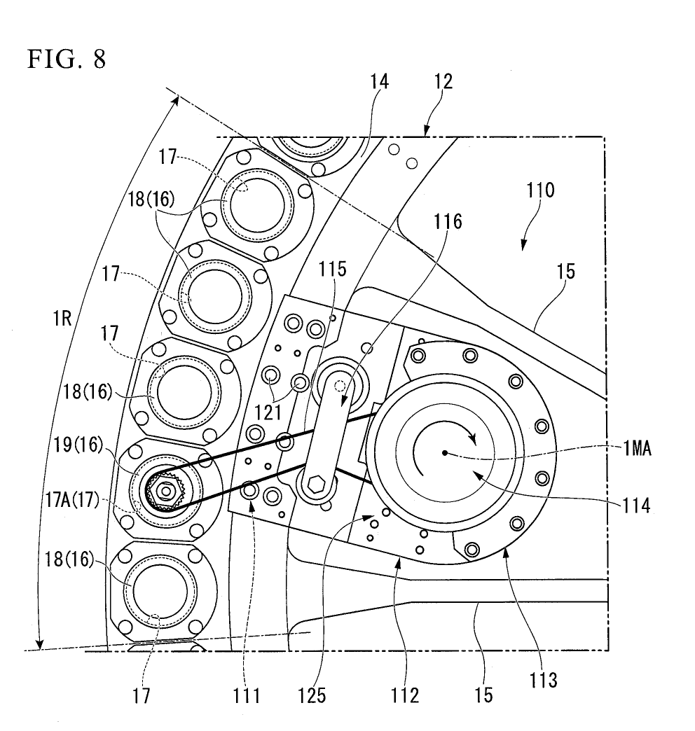

In the modified example shown in FIG. 8, the attachment hole 17 that is disposed next to the attachment hole 17 disposed at the end portion on the other side (the lower side in FIG. 8) in the table circumferential direction toward one side (the upper side in FIG. 8) among five attachment holes 17 included in the predetermined region 1R is set as the predetermined attachment hole 17A. The motor attachment flange 113 is fixed to the motor plate 112 while its position is adjusted so that (the tool spindle of) the rotational processing tool 19 is disposed in the predetermined attachment hole 17A and the opening portion 125 is opened toward the rotational processing tool 19.

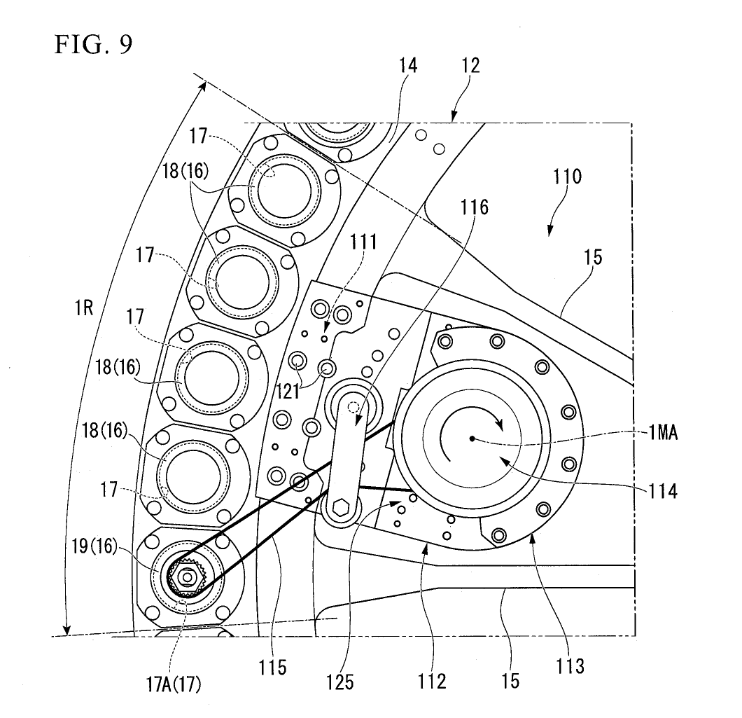

In the modified example shown in FIG. 9, the attachment hole 17 that is disposed at the other end portion (the lower side in FIG. 9) in the table circumferential direction among five attachment holes 17 included in the predetermined region 1R is set as the predetermined attachment hole 17A. The motor attachment flange 113 is fixed to the motor plate 112 while its position is adjusted so that (the tool spindle of) the rotational processing tool 19 is disposed in the predetermined attachment hole 17A and the opening portion 125 is opened toward the rotational processing tool 19.

In this way, according to the embodiment, the opening portion 125 of the motor attachment flange 113 can be disposed to be open in straight line to the rotational processing tool 19 irrespective of the attachment hole 17 among the plurality of attachment holes 17 in the predetermined region 1R to which the rotational processing tool 19 is provided. For this reason, the rotational processing tool 19 and the die processing tool 18 can be disposed to be freely switched in the predetermined region 1R.

In the description above, the number of attachment holes 17 included in the predetermined region 1R is five, but the present invention is not limited thereto. For example, the number of attachment holes 17 included in the predetermined region 1R may be four or less or six or more.

According to the above-described embodiment, it is possible to easily dispose the corresponding driving motor 114 for rotating the spindle even when the arrangement position of the spindle (the tool spindle of the rotational processing tool 19) attached to any one of the plurality of attachment holes 17 arranged in the processing table 12 is changed. Specifically, in the embodiment, it is possible to easily change the arrangement order of the plurality of processing tools 16 arranged in the table circumferential direction of the processing table 12 and thus to increase the number of can processing types (variations).

Further, since the above-described operational effects can be obtained by a simple operation in which the opening portion 125 of the motor attachment flange 113 is adjusted to face the tool spindle of the rotational processing tool 19 switched to any one of the plurality of attachment holes 17 of (in the predetermined region R) the processing table 12, the workability is satisfactory.

Furthermore, in the embodiment, the predetermined region 1R can be set anywhere in the table circumferential direction of the processing table 12 or can be provided at a plurality of positions in the table circumferential direction. In this case, since the degree of freedom of selecting the predetermined attachment hole 17A to which the rotational processing tool 19 is attached increases, the above-described effects of the embodiment are more significant.

Further, in the embodiment, since the belt tensioner 116 is disposed in the motor plate 112 so that its position is adjustable in accordance with the predetermined attachment hole 17A to which the tool spindle of the rotational processing tool 19 is attached among the plurality of attachment holes 17 (included in the predetermined region R) of the processing table 12, the following operational effects can be obtained.

That is, in the embodiment, as described above with reference to FIGS. 5 to 9, the tool spindle of the rotational processing tool 19 can be attached to any attachment hole 17 among the plurality of attachment holes 17 (included in the predetermined region 1R) of the processing table 12. For that reason, the position of the transfer member 115 wound on the tool spindle and the driving motor 114 also changes in response to the attachment position of the tool spindle of the rotational processing tool 19.

As shown in FIGS. 5 to 9, when the position of the belt tensioner 116 attached to the motor plate 112 is adjustable, it is possible to apply a desired tension by reliably bringing the belt tensioner into contact with the belt even when the position of the belt corresponding to the transfer member 115 changes in response to the attachment position of the tool spindle of the rotational processing tool 19.

According to the above-described configuration, since the tensile force (the tension load or the tension) of the belt corresponding to the transfer member 115 can be stably maintained at a predetermined value or more regardless of the attachment position of the tool spindle of the rotational processing tool 19, it is possible to efficiently and stably transfer the rotational driving force of the driving motor 114 to the tool spindle of the rotational processing tool 19.

When a distance between the tool spindle and the driving motor 114 greatly changes in response to the attachment position of the tool spindle of the rotational processing tool 19, the belt of the transfer member 115 may be appropriately changed in size or replaced.

In the embodiment, a base is a table. Specifically, the table is the processing table 12 and the plurality of attachment holes 17 are arranged over the entire periphery of the processing table 12 in the table circumferential direction. Thus, it is possible to obtain the operational effects of the above-described embodiment over the entire periphery of the processing table 12 in the table circumferential direction. That is, since it is possible to dispose the tool spindle of the rotational processing tool 19 in any one of the plurality of attachment holes 17 arranged over the entire periphery of the processing table 12, it is possible to perform various processes on the can that is a workpiece.

Specifically, since the predetermined region 1R of the processing table 12 is provided at a plurality of positions over the entire periphery in the table circumferential direction, it is possible to obtain the operational effects of the above-described embodiment in each of the predetermined regions 1R. Thus, since the rotational processing tools 19 can be freely disposed over the entire periphery of the processing table 12, it is possible to greatly increase the number of can processing types (variations).

In the embodiment, since the motor attachment flange 113 is attached to the motor plate 112 while rotating around the motor axis 1MA of the driving motor 114, the position of the motor attachment flange is disposed to be adjustable and thus the following operational effects are obtained.

That is, in the above-described configuration, since the motor attachment flange 113 is reattached to the motor plate 112 while rotating around the motor axis 1MA, the opening portion 125 of the motor attachment flange 113 can be disposed to face the tool spindle of the rotational processing tool 19. For this reason, an operation of adjusting the position so that the opening portion 125 of the motor attachment flange 113 is opened toward the predetermined attachment hole 17A to which the tool spindle of the rotational processing tool 19 is attached among the plurality of attachment holes 17 arranged in (the predetermined region 1R of) the processing table 12 is easy and the position of the driving motor 114 having a large weight (the position of the motor axis 1MA) does not change before and after the position is adjusted.

Even when the arrangement position of the tool spindle of the rotational processing tool 19 in the processing table 12 is changed, the position of the motor attachment flange 113 can be adjusted without substantially changing the arrangement of the driving motor 114 by rotating the motor attachment flange 113 around the motor axis 1MA in response to the position adjustment. Accordingly, the weight balance of the processing table 12 does not greatly change and the processing of the can corresponding to a workpiece is stably performed in the can manufacturing apparatus 11 including the rotational processing tool driving structure (the spindle rotation unit) 110.

Thus, even when the arrangement order of the plurality of processing tools 16 arranged in the processing table 12 is changed, the weight balance of the processing table 12 does not greatly change and the bottle cans are stably manufactured by the can manufacturing apparatus 11. Accordingly, good quality of the bottle cans can is maintained.

In the embodiment, since the driving motor 114 is supported by the motor attachment flange 113 in a region of at least 180° or more around the motor axis 1MA, the following operational effects are obtained.

In this case, since it is possible to secure a sufficiently wide region in which the motor attachment flange 113 supports the driving motor 114 while forming the opening portion 125 through which the transfer member 115 is inserted in the motor attachment flange 113, the driving motor 114 is stably supported by the motor attachment flange 113. Since the driving motor 114 is supported by the motor attachment flange 113 in a region of 180° or more around the motor axis 1MA including both outer portions in the radial direction based on at least the motor axis 1MA, it is possible to sufficiently secure the attachment stability of the driving motor 114 with respect to the motor attachment flange 113.

Further, in the embodiment, since the processing table 12 includes the inner ring body 13, the outer ring body 14, and the plurality of ribs 15 that connect the ring bodies 13 and 14 to each other in the table radial direction and are arranged at intervals in the table circumferential direction, the width of the motor plate 112 in the table circumferential direction is smaller than a distance between the ribs 15 that are adjacent to each other in the table circumferential direction. Accordingly, the following operational effects are obtained.

That is, according to the above-described configuration, since the width of the motor plate 112 (the length in the table circumferential direction) is smaller than the distance between the ribs 15 that are adjacent to each other in the table circumferential direction (the length in the table circumferential direction), the motor plate 112 can be disposed to be received between these ribs 15.

In this case, the motor plate 112 can be easily disposed in the processing table 12 without, for example, a troublesome operation of securing an attachment space for the motor plate 112 by cutting a part of the plurality of ribs 15 densely arranged in the table circumferential direction. Further, the strength of the processing table 12 is also stably secured.

Since it is possible to easily adjust the height positions of (the motor pulley 131 of) the driving motor 114 attached to the motor plate 112 through the motor attachment flange 113 and (the tool spindle of) the rotational processing tool 19 in the direction of the motor axis 1MA (or the axial direction of the tool spindle), these components can be easily and reliably connected to each other by the transfer member 115 and the connection state therebetween is also stabilized.

The present invention is not limited to the above-described embodiment and various modifications can be made without departing from the spirit of the present invention.

For example, in the above-described embodiment, the processing table 12 is provided with the plurality of attachment holes (attachment portions) 17 penetrating the processing table 12 in the direction of the table axis 1TA and the processing tools 16 are attachable to the attachment holes 17, but the shape of the attachment portion to which the processing tool 16 is attached is not limited to a penetration hole. For example, the attachment portion to which the processing tool 16 is attachable may be a semi-circular notch or the like open to the outer peripheral surface of the processing table 12.

In the above-described embodiment, the plate attachment hole group (the plate attachment portion) 111 is formed in (the predetermined region R of) the processing table 12 and the bolt 121 is threaded into the plate attachment hole group 111 so that the motor plate 112 is attached, but a method of attaching the motor plate 112 to (the predetermined region 1R of) the processing table 12 is not limited to threading. That is, the shape of the plate attachment portion of the processing table 12 is not limited to a female screw hole. For example, the motor plate 112 may be attached to (the predetermined region 1R of) the processing table 12 by welding or fitting.

In the above-described embodiment, any one attachment hole 17 among the plurality of attachment holes 17 included in one predetermined region 1R of the processing table 12 is set as the predetermined attachment hole 17A. That is, an example in which one rotational processing tool 19 (the spindle) is disposed in one predetermined region 1R has been described, but the present invention is not limited thereto. For example, a plurality of (for example, two) predetermined attachment holes 17A may be formed in one predetermined region 1R and a plurality of rotational processing tools 19 may be arranged according to this number of attachment holes 17A. In this case, a plurality of transfer members 15 connecting one driving motor 114 to a plurality of rotational processing tools 19 in one predetermined region 1R are provided.

The motor attachment flange 113 is disposed in the motor plate 112 to adjust its position so that the opening portion 125 is opened toward the plurality of rotational processing tools 19 attached to the plurality of predetermined attachment holes 17A.

In the above-described embodiment, the motor attachment flange 113 is formed in substantially a C-shape in the plan view, but the present invention is not limited thereto. The motor attachment flange 113 may be formed in various shapes as long as the motor attachment flange is attached to the motor plate 112 while supporting the driving motor 114 and the opening portion 125 through which the transfer member 115 is inserted is formed. For example, the motor attachment flange 113 may be formed in a circular ring plate shape. In this case, the opening portion 125 may be formed in the circumferential wall of the motor attachment flange 113 by forming a window hole penetrating the circumferential wall in the radial direction (the motor radial direction) orthogonal to the motor axis 1MA.

In the above-described embodiment, the transfer member 115 is an annular belt, but the present invention is not limited thereto. The transfer member 115 may be, for example, a chain or gear as long as the transfer member is inserted through the opening portion 125 of the motor attachment flange 113 and the rotational driving force of the driving motor 114 is transferred to the rotational processing tool 19.

However, the transfer member 115 is more desirably a belt as described in the above-described embodiment in consideration of compatibility with the spindle rotation speed of the rotational processing tool 19.

In the above-described embodiment, the predetermined region 1R of the processing table 12 may be provided at a plurality of positions over the entire periphery in the table circumferential direction, but the present invention is not limited thereto. When at least one or more predetermined regions 1R are provided in the processing table 12, the operational effects of the above-described embodiment can be obtained.

In the above-described embodiment, the plurality of attachment holes 17 are arranged over the entire periphery of the processing table 12 in the table circumferential direction, but the present invention is not limited thereto. For example, the attachment holes may be arranged in at least a part of the processing table 12 in the table circumferential direction.

In the above-described embodiment, the motor attachment flange 113 is attached to the motor plate 112 while rotating around the motor axis 1MA of the driving motor 114 so that its position is adjustable, but the present invention is not limited thereto. For example, the motor attachment flange 113 may be attached to the motor plate 112 to move parallel in the arrangement direction of the plurality of attachment holes 17 (the table circumferential direction) (included in the predetermined region 1R) of the processing table 12 so that its position is adjustable. In this case, the belt size of the transfer member 115 can be generally set regardless of the arrangement of the rotational processing tool 19 and the predetermined attachment hole 17A of (inside the predetermined region 1R) the processing table 12.

However, as described in the above-described embodiment, when the motor attachment flange 113 is attached to the motor plate 112 while rotating around the motor axis 1MA of the driving motor 114 so that its position is adjustable, the outer shape of the motor plate 112 can formed in a compact size and the position of the motor attachment flange 113 can be easily adjusted. Further, since there is hardly any influence on the weight balance of the processing table 12 due to the movement of the driving motor 114, this configuration is more desirable.

In the above-described embodiment, the driving motor 114 is supported by the motor attachment flange 113 in a region of at least 180° or more around the motor axis 1MA, but the present invention is not limited thereto. The driving motor 114 may be supported by the motor attachment flange 113 in a region smaller than 180° around the motor axis 1MA. For example, the driving motor 114 may be supported by the motor attachment flange 113 in at least three or more positions including two rotationally symmetric positions of 180° around the motor axis 1MA and one position located between these two positions around the motor axis 1MA. In this case, there is a case in which a region in which the driving motor 114 is supported by the motor attachment flange 113 around the motor axis 1MA is smaller than 180° in total.

However, as described above in the above-described embodiment, when the driving motor 114 is supported by the motor attachment flange 113 in a region of at least 180° or more around the motor axis 1MA, a state in which the driving motor 114 is supported by the motor attachment flange 113 becomes significantly stable. Accordingly, this configuration is more desirable.

In the above-described embodiment, an example of a bottle can manufacturing apparatus that manufactures a bottle can by performing various processes on a bottomed cylinder can has been described as the can manufacturing apparatus 11, but the present invention is not limited thereto. For example, the can manufacturing apparatus 11 may be an aerosol can manufacturing apparatus that manufactures an aerosol can by performing various processes on a bottomed cylinder can or a can manufacturing apparatus that manufactures a can other than a bottle can and an aerosol can.

For example, the spindle rotation unit of the present invention can also be applied to another can processing apparatus such as a can coating apparatus and a can inspection apparatus other than the above-described can manufacturing apparatus. In this case, for example, the can processing apparatus may hold a can by a plurality of chucks (attachment portions) arranged in the table (base) and rotate a spindle of the chuck by a driving motor so that the chuck rotates.

Further, the application of the spindle rotation unit of the present invention is not limited to the can processing apparatus and the spindle rotation unit can be also applied to a workpiece processing apparatus that performs various processes (including manufacturing, painting, inspection, and other various processes) on a workpiece such as a bottomed cylinder body or a columnar body other than a can.

As described above, when the spindle rotation unit of the present invention is applied to the can processing apparatus other than a can manufacturing apparatus or a workpiece processing apparatus processing a workpiece other than a can, a plurality of attachment portions of the table (base) may be arranged in any one of the outer ring body and the inner ring body. The shape of the table is not limited to a double ring shape, and may be a simple disk shape or the like. The table may not be used as the base.

### First Embodiment of can Manufacturing Apparatus and Processing Table Structure Thereof

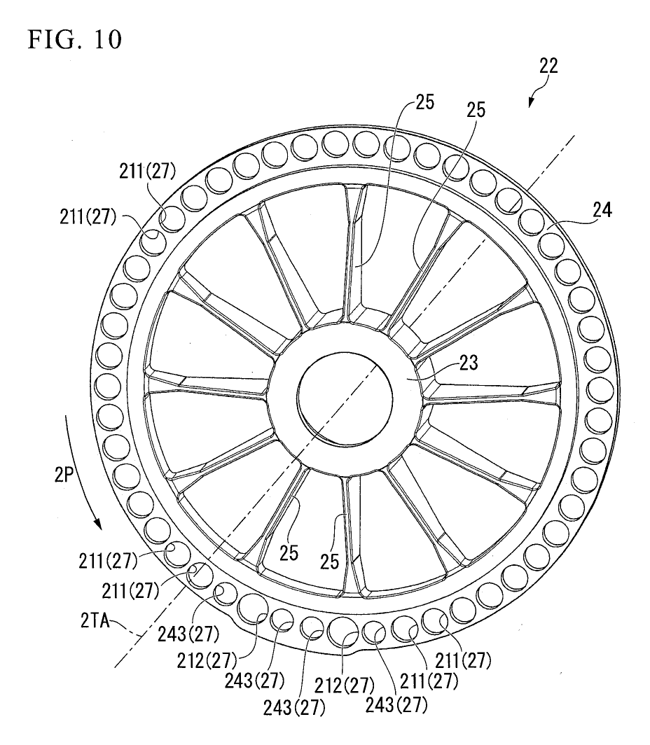

Next, a first embodiment of a can manufacturing apparatus and a processing table structure 210 of the present invention will be described with reference to FIGS. 10 to 13.

The can manufacturing apparatus of the embodiment is a so-called bottle necker that manufactures a bottle can having a desired shape by performing various bottle necking processings including die processing and rotational processing on a bottomed cylinder can.

A can that is supplied as a workpiece to the can manufacturing apparatus is a DI can having been subjected to DI processing in a previous step. The DI can is formed in a bottomed cylindrical shape by applying a capping step (a drawing step), a drawing and ironing step (DI) step, and the like to a disk-shaped blank punched out from a plate material of an aluminum alloy material. The bottle can manufactured by the can manufacturing apparatus is filled with contents such as a beverage in a later step and a cap is screwed thereonto.

The can manufacturing apparatus includes a processing table 22 and a holding table (not shown) that are disposed to face each other. The processing table 22 and the holding table are disposed so that the center axes (the table axes TA) extend in the horizontal direction and the center axes are coaxially disposed.

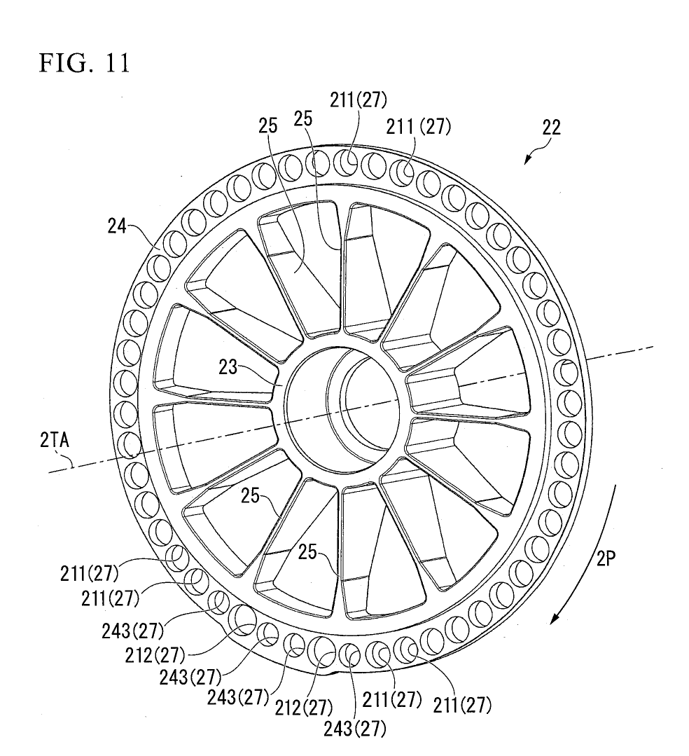

FIGS. 10 and 11 show the processing table 22. FIG. 10 is a perspective view in which a surface facing the side opposite to the holding table among both surfaces of the processing table 22 facing the direction of the table axis 2TA is substantially viewed from the front side and FIG. 11 is a perspective view in which a surface on the side of the holding table among both surfaces of the processing table 22 is substantially viewed from the front side.

In the embodiment, a direction in which the table axis 2TA (an extension direction of the table axis 2TA) is aligned will be referred to as the direction of the table axis 2TA.

A direction orthogonal to the table axis 2TA will be referred to as a table radial direction. In the table radial direction, a direction of moving away from the table axis 2TA will be referred to as an outside in the table radial direction and a direction of moving closer to the table axis 2TA will be referred to as an inside in the table radial direction.

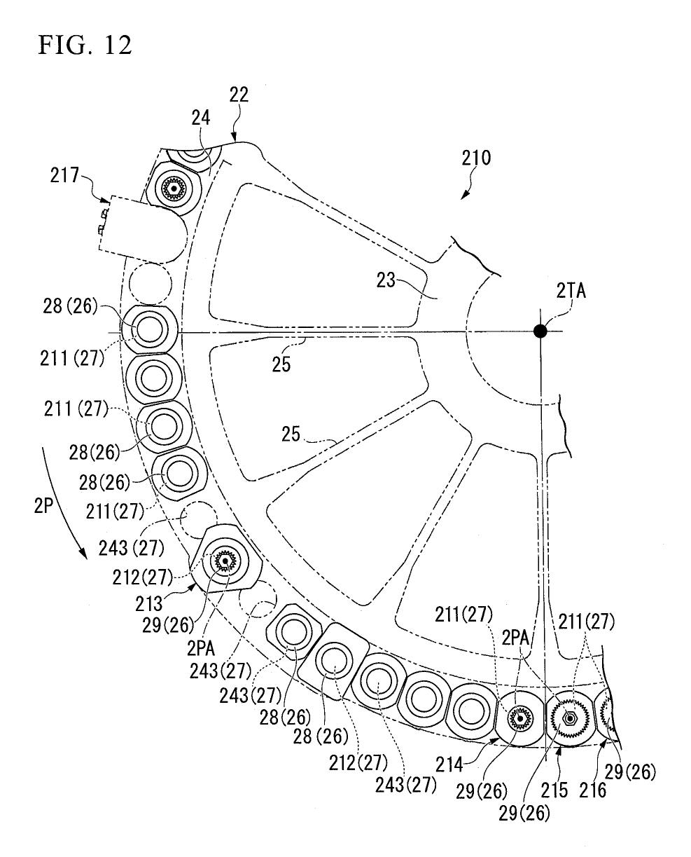

A direction around the table axis 2TA will be referred to as a table circumferential direction. As shown in FIG. 12, a direction in which a plurality of processing tools 26 to be described later are arranged in the processing table 22 in the table circumferential direction according to a can processing procedure will be referred to as a processing procedure downstream direction (a processing procedure direction) 2P and a direction opposite thereto will be referred to as a processing procedure upstream direction (an side opposite to the processing procedure direction). The holding table that holds the can is intermittently rotated toward the processing procedure downstream side 2P in the table circumferential direction with respect to the processing table 22.

A direction (an extension direction of a processing tool axis 2PA) along the processing tool axis (the rotation center axis of the tool spindle) 2PA of a center/outer member type rotational processing tool 213 to be described later will be referred to as a direction of the processing tool axis 2PA. In the embodiment, the table axis 2TA and the processing tool axis 2PA are parallel to each other.

A direction orthogonal to the processing tool axis 2PA will be referred to as a processing tool radial direction. A direction of moving away from the processing tool axis 2PA in the processing tool radial direction will be referred to as an outside in the processing tool radial direction and a direction of moving closer to the processing tool axis 2PA will be referred to as an inside in the processing tool radial direction.

A direction around the processing tool axis 2PA will be referred to as a processing tool circumferential direction.

Although particularly not shown in the drawings, the can manufacturing apparatus includes a main body frame that supports the processing table 22 and the holding table. The main body frame is provided with a table driving unit and the table driving unit includes a table driving motor, a connection shaft, and a crank mechanism.

The processing table 22 and the holding table are repeatedly moved closer to and away from the table axis 2TA and are intermittently and relatively rotated in the table circumferential direction by the table driving unit of the main body frame. Specifically, the processing table 22 is moved closer to and away from the direction of the table axis 2TA with respect to the holding table and the holding table is rotated by a predetermined amount in the table circumferential direction with respect to the processing table 22 during one approaching/separating stroke (reciprocating movement).

For each stroke in which the processing table 22 and the holding table move closer to and away from each other, a can held by the holding table is processed by a processing tool 26 provided in the processing table 22 and the holding table moves the can to a processing position by the next (different) processing tool 26 on the processing procedure downstream side P.

When this operation is repeated, the can held by the holding table is sequentially processed by the processing tools 26 provided in the processing table 22 and a bottle can having a desired shape has been manufactured at a time point at which a processing series ends.

The holding table is generally called a turntable. Although particularly not shown in the drawings, the holding table is formed in a disk shape or a circular ring shape. A plurality of chucks (can holders) are arranged in the table circumferential direction on an outer circumferential portion of a surface facing the processing table 22 in the holding table. Cans are respectively held by the chucks and opening end portions of the held cans are opened toward the processing table 22.

For the configurations of the holding table and the main body frame of the can manufacturing apparatus 11 of the embodiment, for example, known configurations disclosed in Japanese Unexamined Patent Application, First Publication No. 2005-329424 can be used.

The processing table 22 is generally called a die table. In FIGS. 10 and 11, the processing table 22 is formed in a disk shape or a circular ring shape. In this embodiment, the processing table 22 is formed in a double ring shape.

Specifically, the processing table 22 includes an inner ring body 23 that is connected to a connection shaft of the main body frame, an outer ring body 24 that is disposed outward from the inner ring body 23 in the table radial direction and is coaxial therewith, and a plurality of ribs 25 that connect the ring bodies 23 and 24 in the table radial direction and are disposed at intervals in the table circumferential direction.

In the example shown in the drawings, twelve ribs 25 are arranged at equal intervals in the table circumferential direction between the inner ring body 23 and the outer ring body 24 and the number of gaps (spaces) formed between the ribs 25 adjacent to each other in the table circumferential direction is also twelve.

In the embodiment, the length of the inner ring body 23 in the direction of the table axis 2TA is set to be larger than the length of the outer ring body 24 in the direction of the table axis 2TA. Accordingly, the length of the rib 25 in the direction of the table axis 2TA is also formed to gradually increase from a portion connected to the outer ring body 24 inward in the table radial direction and becomes maximum at a portion connected to the inner ring body 23.

The thickness of the rib 25 (the size in the table circumferential direction) becomes maximum at a portion connected to the outer ring body 24 in an outer end portion of the rib 25 in the table radial direction and gradually decreases inward in the table radial direction from this portion. In a portion other than the outer end portion of the rib 25 in the table radial direction, the thickness of the rib 25 becomes substantially uniform in the table radial direction.

As shown in FIG. 12, the processing tools 26 that process the can held by the holding table are arranged in the table circumferential direction of the processing table 22. These processing tools 26 are arranged in the table circumferential direction on an outer circumferential portion of a surface facing the holding table in the processing table 22 and are disposed to respectively face the plurality of cans held by the holding table from the direction of the table axis 2TA. The processing tool axis (the center axis) of the processing tool 26 of the processing table 22 and the can axis of the can facing the processing tool 26 in the holding table are coaxially disposed. That is, the can is processed by the processing tool 26 while the can axis is aligned with the processing tool axis.

FIG. 12 shows only a part of the plurality of processing tools 26 arranged in the table circumferential direction of the processing table 22 and shows the arrangement state of the processing tools 26 when a surface opposite to the holding table among both surfaces facing the direction of the table axis 2TA of the processing table 22 is viewed from the front side.

As shown in FIGS. 10 and 11, the processing table 22 is provided with a plurality of attachment holes 27 arranged in the table circumferential direction to penetrate the processing table 22 in the direction of the table axis 2TA. The plurality of processing tools 26 are attachable to the attachment holes 27 according to the can processing procedure.

The attachment hole 27 opens to an outer circumferential portion of a surface facing the holding table in the processing table 22 and is formed to penetrate to a surface facing the side opposite to the holding table in the outer circumferential portion. In the embodiment, the plurality of attachment holes 27 are formed in the outer ring body 24 and are arranged in the table circumferential direction. In the example shown in the drawings, the number of the attachment holes 27 formed in the processing table 22 is fifty. The attachment hole 27 will be separately described in detail later.

As shown in FIG. 12, the plurality of processing tools 26 include a die processing tool 28 and a rotational processing tool 29. In the embodiment, the plurality of die processing tools 28 and the plurality of rotational processing tools 29 are arranged to be attachable to and separable from the plurality of attachment holes 27 of the processing table 22 according to the can processing procedure. Some of the plurality of attachment holes 27 may be empty spaces to which the processing tools 26 are not attached.

The die processing tool 28 moves in the can axial direction (a direction parallel to the table axis 2TA) with respect to the can and performs die processing such as drawing processing for decreasing the diameter of the circumferential wall of the can or expanding processing for increasing the diameter of the circumferential wall. One die processing tool 28 performs one type of die processing on the can.

The die processing tool 28 includes a mold that performs die processing on the can and a mold holder that is separably attached to the attachment hole 27 and holds the mold. In FIG. 12, the mold holder of the die processing tool 28 is shown.

The rotational processing tool 29 rotates about the can axis with respect to the can and performs rotational processing such as trimming processing, screw forming processing, curling processing, and throttle (curl caulking) processing on the circumferential wall of the can with the rotation about the can axis. One rotational processing tool 29 performs one type of rotational processing on the can.

The rotational processing tool 29 includes a molding portion that performs rotational processing on the can and a tool spindle that is separably attached to the attachment hole 27 and supports the molding portion to be rotatable around the processing tool axis 2PA (the center axis of the rotational processing tool 29) with respect to the attachment hole 27. The tool spindle includes a plate portion that is attached to the attachment hole 27 and a spindle shaft portion that is formed to penetrate the plate portion while being rotatable around the processing tool axis 2PA (the processing tool circumferential direction) and is connected to the molding portion. In FIG. 12, the tool spindle of the rotational processing tool 29 is shown.

Although particularly not shown in the drawings, (the spindle shaft portion of) the tool spindle is connected to the driving motor through a transfer member such as a belt. The driving motor is disposed in the processing table 22. The spindle shaft portion of the tool spindle is rotated around the processing tool axis 2PA by a rotational driving force transferred from the driving motor and the molding portion performs rotational processing on the can by using the rotational force.

The processing table 22 is provided with the rotational processing tools 29 including a small outer diameter rotational processing tool 29 such as a trimming processing tool, a curl processing tool, and a throttle (curl caulking) processing tool and a large outer diameter rotational processing tool 29 such as a screw forming processing tool. In this embodiment, the center/outer member type rotational processing tool 213 is included in the large outer diameter rotational processing tools 29.

The processing table structure 210 of the can manufacturing apparatus of the embodiment includes the processing table 22 and the plurality of processing tools 26 attachable to the processing table 22. Then, at least the center/outer member type rotational processing tool 213 is provided as the rotational processing tool 29 among the die processing tool 28 and the rotational processing tools 29 included in the plurality of processing tools 26.

Although particularly not shown in the drawings, the center/outer member type rotational processing tool 213 includes a center member that is disposed to face the inner peripheral surface of the circumferential wall of the can and an outer member that is disposed to face the outer peripheral surface of the circumferential wall of the can and gives a predetermined shape to the circumferential wall by sandwiching the circumferential wall of the can while moving the center member and the outer member closer to each other.

In the embodiment, one center/outer member type rotational processing tool 213 is provided as the large diameter rotational processing tool 29 among the plurality of processing tools 26 arranged in the processing table 22 and the center/outer member type rotational processing tool 213 is a screw forming processing tool. For the configuration of the screw forming processing tool 213, for example, a known configuration disclosed in Japanese Unexamined Patent Application, First Publication No. 2004-74170 can be used.

Since the screw forming processing tool 213 is the rotational processing tool 29, the screw forming processing tool includes the molding portion and the tool spindle as described above. The molding portion of the screw forming processing tool 213 is provided with a center member that is inserted into the can and is disposed to face the inner peripheral surface of the mouth portion of the can (the circumferential wall of the can) and an outer member that is disposed to face the outer peripheral surface of the mouth portion when the holding table and the processing table 22 move closer to each other in the direction of the table axis 2TA. The molding portion of the screw forming processing tool 213 is provided with a cam roller mechanism or the like operated according to (moving in synchronization with) the approaching movement of the holding table and the processing table 22 and the center member and the outer member are moved closer to each other by the cam roller mechanism or the like to sandwich the mouth portion of the can.

In this way, the molding portion of the screw forming processing tool 213 is rotated around the processing tool axis 2PA with respect to the processing table while the center member and the outer member sandwich the mouth portion of the can. The molding portion of the screw forming processing tool 213 is provided with a gear mechanism or the like operated in accordance with the rotation and the center member and the outer member are rotated (revolved) around the can axis while reversely rotating (spinning) around respective axes thereof in synchronization with each other and sandwiching the mouth portion of the can using the gear mechanism or the like so that both members roll on the mouth portion. Accordingly, the mouth portion of the can is formed in a predetermined shape by performing screw forming processing on the entire periphery of the mouth portion.

An example of the arrangement of the plurality of processing tools 26 in the processing table structure 210 shown in FIG. 12 corresponds to a case of manufacturing the bottle can having a diameter of 38 mm. The screw forming processing tool 213 performs screw forming processing corresponding to a diameter of 38 mm on the mouth portion of the can.

In view of the structure of the screw forming processing tool 213 that is a center/outer member type rotational processing tool, its outer diameter is larger than the outer diameter of the rotational processing tools 29 other than the screw forming processing tool 213 or the die processing tool 28 in the processing tools 26. Specifically, the outer diameter of the molding portion of the screw forming processing tool 213 is set to be larger than the outer diameter of the molding portion of the rotational processing tools 29 other than the screw forming processing tool 213. The outer diameter of the tool spindle (the spindle shaft portion) inserted into the attachment hole 27 in the screw forming processing tool 213 is set to be larger than the outer diameter of the tool spindle of the rotational processing tools 29 other than the screw forming processing tool 213.

In the example shown in FIG. 12, processing tool 26 are not attached to the pair of attachment holes 27 adjacently disposed at both sides of the screw forming processing tool 213 in the table circumferential direction in consideration of the interference with the screw forming processing tool 213 and the attachment holes 27 are formed as an empty space.

In the plurality of rotational processing tools 29 shown in FIG. 12, reference numeral 214 denotes a trimming processing tool, reference numeral 215 denotes a curl processing tool, and reference numeral 216 denotes a throttle processing tool.

Reference numeral 217 in FIG. 12 denotes an oiling tool that is neither a die processing tool 28 nor a rotational processing tool 29.

As shown in FIGS. 10 and 11, the plurality of attachment holes 27 in the processing table 22 are arranged at equal intervals in the table circumferential direction. That is, the arrangement pitch (the center angle around the table axis 2TA) of the center lines (the hole centers) of the attachment holes 27 that are adjacent to each other in the table circumferential direction is set to be the same over the entire periphery in the table circumferential direction. In this embodiment, since fifty attachment holes 27 are formed at equal intervals in the processing table 22, the arrangement pitch between the adjacent attachment holes 27 in the table circumferential direction is 7.2°.

The plurality of attachment holes 27 arranged in the processing table 22 in the table circumferential direction include a first attachment hole (a standard diameter hole) 211, a second attachment hole (a large diameter hole) 212 having an inner diameter larger than that of the first attachment hole 211, and a third attachment hole (a small diameter hole) 243 having an inner diameter smaller than that of the first attachment hole 211.

The first attachment hole 211, the second attachment hole 212, and the third attachment hole 243 are formed as penetration holes having a circular cross-section and penetrating the processing table 22 in the direction of the table axis 2TA (the table thickness direction). Further, in the embodiment, for example, the pitch circle diameters P.C.D of the plurality of attachment holes 27 arranged in the processing table 22 in the table circumferential direction are φ1580 mm, the inner diameter of the first attachment hole (the standard diameter hole) 211 is φ85 mm, the inner diameter of the second attachment hole (the large diameter hole) 212 is φ110 mm or φ100 mm, and the inner diameter of the third attachment hole (the small diameter hole) 243 is φ75 mm.

The die processing tool 28 or the rotational processing tool 29 (that is, the small outer diameter rotational processing tool) other than the center/outer member type rotational processing tool 213 (the large outer diameter rotational processing tool) is attachable to the first attachment hole 211, the second attachment hole 212, and the third attachment hole 243. Further, the center/outer member type rotational processing tool 213 is also attachable to the second attachment hole 212. In other words, all processing tools 26 are attachable to the second attachment hole 212. Meanwhile, the center/outer member type rotational processing tool 213 corresponding to the large diameter rotational processing tool 29 is not attachable to the first attachment hole 211 and the third attachment hole 243.

At least two or more second attachment holes 212 are provided in the plurality of attachment holes 27 arranged in the processing table 22 in the table circumferential direction. In this embodiment, two second attachment holes 212 are provided in the processing table 22.

In the example shown in the drawings, in the outer periphery of the processing table 22, portions respectively corresponding to the outer portions of two second attachment holes 212 in the table radial direction and a region located between these portions protrude outward in the table radial direction and have a larger outer diameter compared to other portions (a portion other than the above-described portions and the above-described region in the outer periphery of the processing table 22).

At least one or more attachment holes 27 (that is, any one of the first attachment hole 211 and the third attachment hole 243) other than the second attachment hole 212 are disposed between second attachment holes 212 adjacent to each other in the table circumferential direction of the processing table 22. In this embodiment, the third attachment holes 243 are adjacently disposed at both sides of the second attachment hole 212 in the table circumferential direction. A wide gap (space) is provided between the second attachment holes 212 adjacent to each other in the table circumferential direction and two third attachment holes 243 are disposed in this space.

Specifically, a large enough arrangement pitch (the length in the table circumferential direction, that is, a center angle around the table axis 2TA) between the pair of large diameter second attachment holes 212 of the processing table 22 is secured such that at least one or more of the first attachment hole 211 having a standard diameter and the third attachment hole 243 having a small diameter can be disposed between the pair of second attachment holes 212.

As shown in FIG. 12, in the embodiment, the screw forming processing tool (the center/outer member type rotational processing tool) 213 is attached to the second attachment hole 212 located on the processing procedure upstream side among the two second attachment holes 212 that are adjacent to each other in the table circumferential direction.

In the example shown in the drawings, four die processing tools 28 are disposed between the screw forming processing tool 213 and the oiling tool 217 located on the processing procedure upstream side in relation to the screw forming processing tool 213. Both of the pair of third attachment holes 243 adjacent to the second attachment hole 212 to which the screw forming processing tool 213 is attached is left as an empty space to which processing tools 26 are not attached.

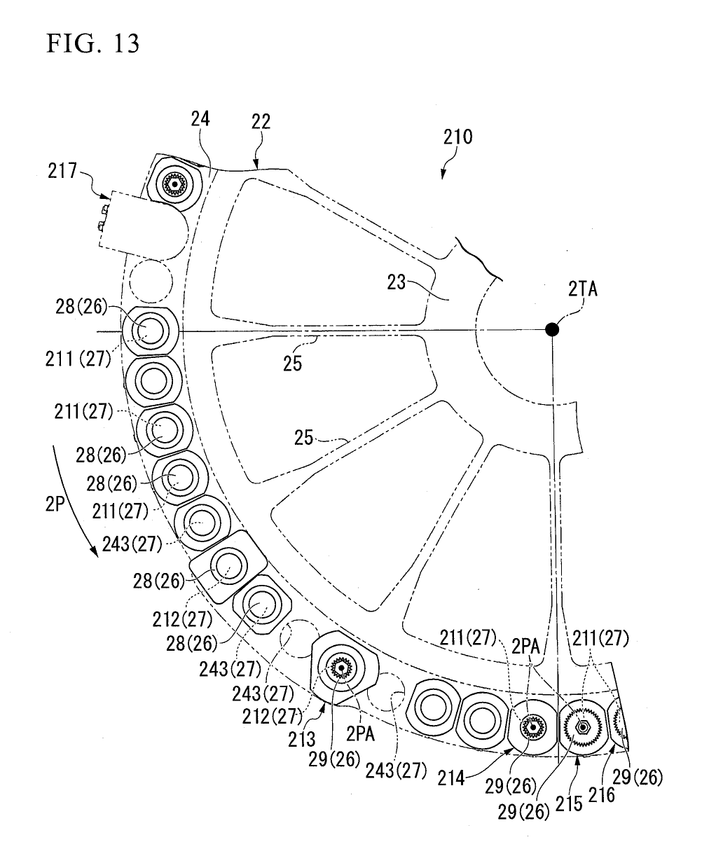

The arrangement of the plurality of processing tools 26 of the processing table structure 210 shown in FIG. 13 is a modified example of the embodiment and corresponds to a case of manufacturing a bottle can having a diameter of 28 mm. The configuration of the processing table 22 is common in FIGS. 12 and 13.

In the modified example shown in FIG. 13, the screw forming processing tool 213 is attached to another second attachment hole 212 located on the processing procedure downstream side 2P rather than the second attachment hole 212 in which the screw forming processing tool 213 is disposed at the time of manufacturing the bottle can having a diameter of 38 mm shown in FIG. 12. The screw forming processing tool 213 performs screw forming processing corresponding to the diameter of 28 mm on the mouth portion of the can.

In the example shown in FIG. 13, seven die processing tools 28 are disposed between the screw forming processing tool 213 and the oiling tool 217 located on the processing procedure upstream side in relation to the screw forming processing tool 213. That is, the number of die processing tools 28 disposed at a position (on the processing procedure upstream side) in front of the screw forming processing tool 213 at the time of manufacturing the bottle can having a diameter of 28 mm shown in FIG. 13 is larger by three than the number in the case of manufacturing the bottle can having a diameter of 38 mm shown in FIG. 12. Both of the pair of third attachment holes 243 that are adjacent to the second attachment hole 212 to which the screw forming processing tool 213 is attached is left as an empty space to which the processing tools 26 are not attached.

In this way, in the processing table structure 210 of the embodiment, various processing tools 26 can be arranged in an attachable and separable manner in response to the desired shape or diameter of the bottle can in the plurality of attachment holes 27 of the processing table 22.

According to the processing table structure 210 of the can manufacturing apparatus of the above-described embodiment, the first attachment hole 211 and the second attachment hole 212 having an inner diameter larger than that of the first attachment hole 211 are included in the plurality of attachment holes 27 arranged in the processing table 22 in the table circumferential direction. At least two or more second attachment holes 212 are formed in the processing table 22. For this reason, the large outer diameter rotational processing tool 29 (in the embodiment, the screw forming processing tool 213) can be attached to the plurality of second attachment holes 212. As will be described below, it is possible to process cans that could not be processed conventionally.

As in the embodiment, it is possible to manufacture a plurality of different bottle cans having different diameters of mouth portions by using one common can manufacturing apparatus at the time of manufacturing bottle cans having mouth portions subjected to screw forming processing.

Specifically, in the embodiment, for example, the outer diameters of the cans are the same as each other, but a bottle can having a diameter of 38 mm and a bottle can having a diameter of 28 mm, that is, the bottle cans having different diameters can be manufactured as below by the screw forming processing of the same can manufacturing apparatus.

According to the embodiment, there is no need to select the second attachment hole 212 of the processing table 22 to which the screw forming processing tool 213 (the large outer diameter rotational processing tool) is attached at the time of manufacturing a bottle can having a diameter of 38 mm or to select the second attachment hole 212 to which the screw forming processing tool 213 is attached at the time of manufacturing a bottle can having a diameter of 28 mm. That is, it is possible to select the second attachment hole 212 to which the screw forming processing tool 213 is attached at the time of manufacturing the bottle can having a diameter of 28 mm from the attachment holes disposed on the processing procedure downstream side P in the table circumferential direction rather than the second attachment hole 212 used to manufacture the bottle can having a diameter of 38 mm. Accordingly, it is possible to easily secure a large number of instances of die processing (particularly, drawing processing) on the bottle can having a diameter of 28 mm smaller in diameter than the bottle can having a diameter of 38 mm.

Thus, both bottle cans having different diameters can be satisfactorily manufactured.

In the description above, a case of manufacturing two types of bottle can including a bottle can having a diameter of 38 mm and a bottle can having a diameter of 28 mm with one can manufacturing apparatus has been described, but the type of diameter of bottle can that can be manufactured is not limited to two types. Although particularly not shown in the drawings, in order to cope with, for example, a case of manufacturing bottle cans having three types of diameter with one can manufacturing apparatus, the number of the second attachment holes 212 provided in the processing table 22 may be set to three. In order to cope with the case of manufacturing bottle cans having four types of diameter, the number of the second attachment holes 212 of the processing table 22 may be set to four. That is, the number of the second attachment holes 212 of the processing table 22 may be set in response to the type of desired diameter of the bottle can.

According to the above-described embodiment, a plurality of large outer diameter rotational processing tools 29 (the screw forming processing tools 213) can be provided in the processing table 22. Accordingly, it is possible to manufacture a plurality of types of can having different diameters with one can manufacturing apparatus.

Further, in the embodiment, since at least one or more attachment holes 27 other than the second attachment hole 212 are disposed between the second attachment holes 212 adjacent to each other in the table circumferential direction of the processing table 22, the following operational effects are obtained.

In a case in which a plurality of types of bottle can having different diameters are manufactured by one can manufacturing apparatus, when the second attachment holes 212 are disposed adjacent to each other without any attachment holes 27 (the first attachment hole 211 or the third attachment hole 243) other than the second attachment hole 212 between the second attachment holes 212 adjacent to each other in the table circumferential direction of the processing table 22 differently from, for example, the above-described configuration described in the embodiment, the following problems may occur.

In this case, the second attachment hole 212 to which the screw forming processing tool 213 is attached at the time of manufacturing a bottle can having a large diameter and the second attachment hole 212 (the second attachment hole 212 disposed on the processing procedure downstream side 2P) different from the second attachment hole 212 to which the screw forming processing tool 213 is attached at the time of manufacturing a bottle can having a small diameter are disposed adjacent to each other (next to each other) in the table circumferential direction. For this reason, it is possible to increase the number of times of die processing (drawing processing) before screw forming processing by one instance at the time of manufacturing a bottle can having a small diameter compared to a case of manufacturing a bottle can having a large diameter. Thus, it is difficult to cope with a case of manufacturing a plurality of types of bottle can having largely different diameters in some cases.

Here, it is desirable to dispose at least one or more attachment holes 27 (the attachment hole 27 having an inner diameter smaller than that of the second attachment hole 212) other than the second attachment hole 212 between the second attachment holes 212 adjacent to each other in the table circumferential direction as in the processing table structure 210 of the can manufacturing apparatus of the embodiment. Accordingly, it is possible to increase the number of times of die processing (particularly, drawing processing) before screw forming processing by two instances or more at the time of manufacturing a bottle can having a small diameter compared to a case of manufacturing a bottle can having a large diameter. Thus, it is easy to cope with a case of manufacturing a plurality of types of bottle can having greatly different diameters.

In this embodiment, two third attachment holes 243 are disposed between the second attachment holes 212 adjacent to each other in the table circumferential direction. Accordingly, it is possible to increase the number of times of die processing before screw forming processing by three instances at the time of manufacturing a bottle can having a small diameter (a bottle can having a diameter of 28 mm) compared to a case of manufacturing a bottle can having a large diameter (a bottle can having a diameter of 38 mm).

In the embodiment, the plurality of attachment holes 27 arranged at equal intervals in the table circumferential direction of the processing table 22 include the first attachment hole (the standard diameter hole) 211, the second attachment hole (the large diameter hole) 212 having an inner diameter larger than that of the first attachment hole 211, and the third attachment hole (the small diameter hole) 243 having an inner diameter smaller than that of the first attachment hole 211. The third attachment holes (the small diameter holes) 243 are respectively disposed adjacent to both sides of the second attachment hole (the large diameter hole) 212 in the table circumferential direction.

Thus, it is possible to prevent a problem in which the attachment holes 27 adjacent to each other in the table circumferential direction communicate with each other or are disposed extremely closer to each other and to stably attach each processing tool 26 to the attachment hole 27 while forming a plurality of second attachment holes 212 having a large inner diameter in the processing table 2. It is possible to prevent an increase in size (diameter) of the processing table 22 while forming a plurality of second attachment holes 212 having a large inner diameter in the processing table 22.

In the embodiment, as least the center/outer member type rotational processing tool 213 is provided as the rotational processing tool 29. Since the outer diameter of the center/outer member type rotational processing tool 213 is larger than the outer diameter of the other rotational processing tools 29 in view of the structure thereof, the rotational processing tool can be attached only to the second attachment hole 212 among the plurality of attachment holes 27.

The screw forming processing tool is used as such a center/outer member type rotational processing tool 213 and the screw forming processing tool 213 can be attached to at least two or more positions of the processing table 22. Thus, it is possible to manufacture a cans having different diameters with one can manufacturing apparatus as described above.

### Second Embodiment of can Manufacturing Apparatus and Processing Table Structure Thereof

Next, a second embodiment of a processing table structure 220 of the can manufacturing apparatus according to the present invention will be described with reference to FIGS. 10, 11, 14, and 15.

A detailed description of components the same as those of the first embodiment will be omitted and only different points therefrom will be mainly described.

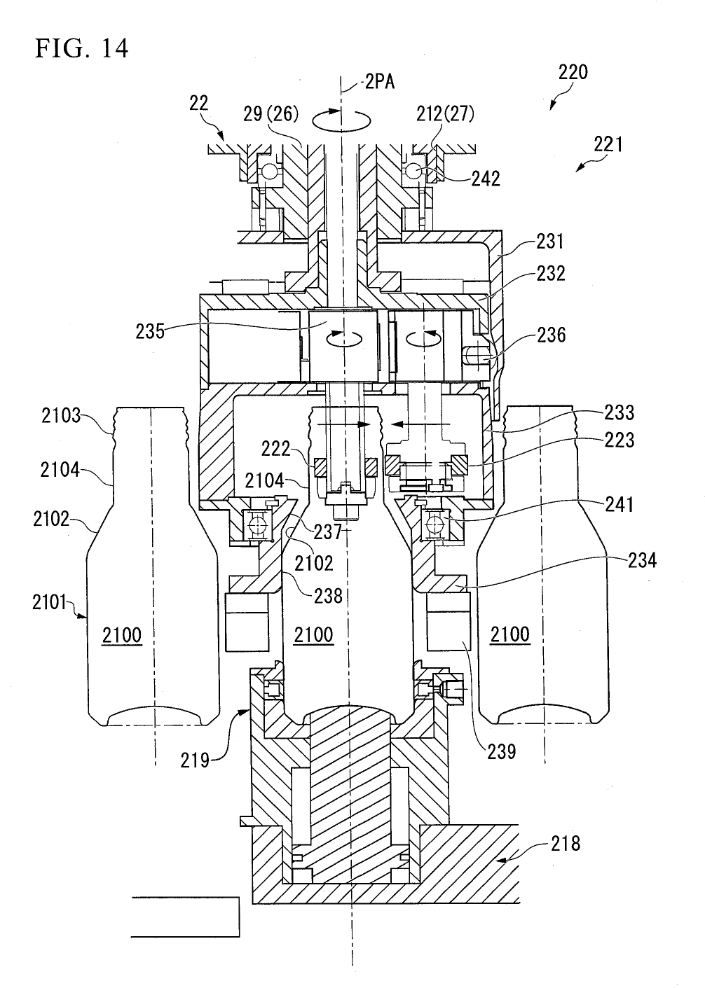

The can manufacturing apparatus of the embodiment manufactures a long neck type bottle can. The long neck type bottle can includes, as shown in FIG. 14, a can bottom (a bottom wall of the can) and a can body (a circumferential wall of the can) 2101. A neck portion 2104 extending in the can axial direction is provided between a shoulder portion 2102 and a mouth portion 2103 of the can body 2101.

In the processing table structure 220 of the can manufacturing apparatus, screw forming processing can be performed on the mouth portion 2103 of a can 2100 and embossing processing can be performed on the neck portion 2104. The processing table structure 220 is provided with at least a center/outer member type rotational processing tool 213 for screw forming processing and a center/outer member type rotational processing tool 221 for embossing processing as the large outer diameter rotational processing tool 29 attached to the processing table 22.

In the embodiment, a plurality of rotational processing tools 29 provided in the processing table 22 rotate around the can axis with respect to the can 2100 and perform rotational processing such as trimming processing, screw forming processing, embossing processing, curl processing, and throttle (curl caulking) processing on the can body (the circumferential wall of the can) 2101 with the rotation around the can axis.

Specifically, in the embodiment, two center/outer member type rotational processing tools 213 and 221 are provided in a plurality of processing tools 26 arranged in the processing table 22 and these center/outer member type rotational processing tools 213 and 221 include the screw forming processing tool 213 and an embossing tool 221.

For the screw forming processing tool 213, the same configuration described in the first embodiment can be used.

Since the embossing tool 221 is the rotational processing tool 29, the embossing tool includes the molding portion and the tool spindle as described in the first embodiment.

In FIG. 14, reference numeral 218 denotes a holding table disposed to face the processing table 22 and reference numeral 219 denotes a plurality of chucks (can holders) provided at intervals in the table circumferential direction of the holding table 218 and respectively holding the cans 2100.

In the following description of the embossing tool (the center/outer member type rotational processing tool) 221, a direction in which the processing tool axis (the rotation center axis of the tool spindle) 2PA of the embossing tool 221 (an extension direction of the processing tool axis 2PA) is aligned will be referred to as the direction of the processing tool axis 2PA. In the embodiment, the table axis 2TA and the processing tool axis 2PA are parallel to each other.

A direction orthogonal to the processing tool axis 2PA will be referred to as a processing tool radial direction. In the processing tool radial direction, a direction of moving away from the processing tool axis 2PA will be referred to as an outside in the processing tool radial direction and a direction of moving closer to the processing tool axis 2PA will be referred to as an inside in the processing tool radial direction.

A direction around the processing tool axis 2PA will be referred to as a processing tool circumferential direction.

As shown in FIG. 14, the molding portion of the embossing tool 221 is provided with a center member 222 that is inserted into the can 2100 and is disposed to face the inner peripheral surface of the neck portion (the circumferential wall of the can) 2104 of the can 2100 and an outer member 223 that is disposed to face the outer peripheral surface of the neck portion 2104 when the holding table 218 and the processing table 22 move closer to each other in the direction of the table axis 2TA (the vertical direction in FIG. 14). The molding portion of the embossing tool 221 is provided with a cam roller mechanism or the like operated according to (moving in synchronization with) the approaching movement of the holding table 218 and the processing table 22 and the center member 222 and the outer member 223 are moved closer to each other by the cam roller mechanism to sandwich the neck portion 2104 of the can 2100.

In a state where the neck portion 2104 of the can 2100 is sandwiched between the center member 222 and the outer member 223, the molding portion of the embossing tool 221 is rotated around the processing tool axis 2PA with respect to the processing table 22. The molding portion of the embossing tool 221 is provided with a gear mechanism or the like operated in accordance with the rotation and the center member 222 and the outer member 223 are rotated (revolved) around the can axis while reversely rotating (spinning) around each axis in synchronization with each other and sandwiching the neck portion 2104 of the can 2100 by the gear mechanism or the like so that both members roll on the neck portion 2104. Accordingly, the neck portion 2104 of the can 2100 is formed in a predetermined shape by performing embossing processing on at least a part of the entire periphery of the neck portion 2104.

The embossing tool 221 will be described in detail.

In FIG. 14, the axes of the center member 222 and the outer member 223 extend parallel to the processing tool axis 2PA and the center member 222 and the outer member 223 are respectively movable so that a distance between the axes changes, that is, both members are relatively movable closer to or away from each other in a direction perpendicular to the processing tool axis 2PA.

The outer peripheral surfaces of the center member 222 and the outer member 223 are respectively provided with an uneven embossing processing portion (not shown) performing embossing processing on the neck portion 2104 and having a corresponding shape (a shape in which both members are combined with each other by fitting or engaging with the neck portion 2104 interposed therebetween).

In the example shown in FIG. 14, the neck portion 2104 of the can 2100 is formed in a straight neck shape having a substantially uniform diameter in the can axial direction. Accordingly, the outer peripheral surfaces of the center member 222 and the outer member 223 are formed to have a substantially uniform outer diameter in the axial direction.

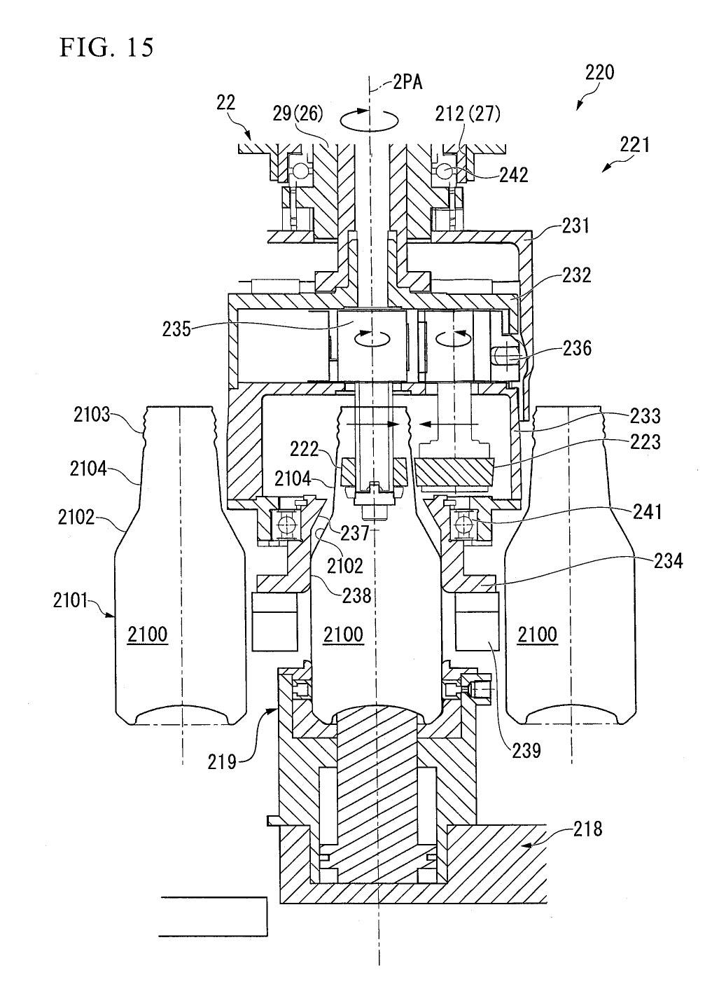

In the modified example shown in FIG. 15, the neck portion 2104 of the can 2100 has a tapered neck shape that gradually decreases in diameter from the shoulder portion 2102 to the mouth portion 2103 in the can axial direction. Accordingly, the outer peripheral surface of the center member 222 is formed to gradually decrease in diameter from the holding table 218 to the processing table 22 in the axial direction of the center member 222 and the outer peripheral surface of the outer member 223 is formed to gradually increase in diameter from the holding table 218 to the processing table 22 in the axial direction of the outer member 223.

In the modified example shown in FIG. 15, the configuration (components) other than the shape of each of the outer peripheral surfaces of the center member 222 and the outer member 223 are to the same as the configuration shown in FIG. 14. Thus, in the description below, a configuration that has not been described in the embossing tool 221 will be described with reference to FIG. 14.

In FIG. 14, the molding portion of the embossing tool 221 includes a first housing 231 that is connected to the tool spindle while the rotation around the processing tool axis 2PA with respect to the tool spindle is restricted and has a topped cylindrical shape, a second housing 232 that is disposed inside the first housing 231, is biased from the processing table 22 toward the holding table 218 in the direction of the processing tool axis 2PA with respect to the first housing 231, is movable in the direction of the processing tool axis 2PA, and has a topped cylindrical shape, a third housing 233 that is connected to the second housing 232 to block an opening end portion facing the holding table 218 of the second housing 232 and has a topped cylindrical shape, and a pressing ring 234 that is rotatably attached to the third housing 233 and protrudes toward the holding table 218.

The center member 222 and the outer member 223 are disposed in the second housing 232 and the third housing 233. A center member cam roller mechanism 235, an outer member cam roller mechanism 236, and a gear mechanism (not shown) reversely rotating the center member 222 and the outer member 223 around respective axes thereof in synchronization in response to the rotation of the tool spindle are disposed between the top wall of the second housing 232 and the top wall of the third housing 233.

When the second housing 232 moves in the direction of the processing tool axis 2PA from the holding table 218 toward the processing table 22 with respect to the first housing 231 (that is, when the top wall of the first housing 231 and the top wall of the second housing 232 move closer to each other), the center member cam roller mechanism 235 can move the center member 222 toward the outer member 223 in accordance with this movement. That is, the center member cam roller mechanism 235 can convert a displacement amount of the second housing 232 in the direction of the processing tool axis 2PA with respect to the first housing 231 into a displacement amount of the center member 222 in the processing tool radial direction.

When the second housing 232 moves in the direction of the processing tool axis 2PA from the holding table 218 toward the processing table 22 with respect to the first housing 231 (that is, when the top wall of the first housing 231 moves closer to the top wall of the second housing 232), the outer member cam roller mechanism 236 can move the outer member 223 toward the center member 222 in accordance with this movement. That is, the outer member cam roller mechanism 236 can convert a displacement amount of the second housing 232 in the direction of the processing tool axis 2PA with respect to the first housing 231 into a displacement amount of the outer member 223 in the processing tool radial direction.

The inner peripheral surface of the pressing ring 234 is provided with a tapered conical surface 237 that gradually decreases in diameter from the holding table 218 toward the processing table 22 in the direction of the processing tool axis 2PA in response to the shape of the shoulder portion 2102 of the can 2100 and a cylindrical surface 238 that slides on the outermost diameter portion (the straight portion) of the can body 2101.

When the embossing tool 221 moves forward with respect to the can 2100, the pressing ring 234 comes into contact with the can 2100 and presses the can 2100.

In FIG. 14, reference numeral 239 denotes a stopper member that is connected to the holding table 218. When the pressing ring 234 comes into contact with the stopper member 239 from the direction of the processing tool axis 2PA, the foremost positions of the third housing 233, the second housing 232, the center member 222, and the outer member 223 in the direction of the processing tool axis 2PA with respect to the holding table 218 and the can 2100 are determined by the pressing ring 234.

In FIG. 14, reference numeral 241 denotes a bearing that connects the pressing ring 234 to the third housing 233 such that they are relatively rotatable around the processing tool axis 2PA.

Reference numeral 242 denotes a bearing that connects the second attachment hole 212 of the processing table 22 and the tool spindle (the spindle shaft portion) of the embossing tool 221 to be relatively rotatable around the processing tool axis 2PA.

In the embossing tool 221 with such a configuration, when the can 2100 held by the chuck 219 is disposed to face the embossing tool 221 in the direction of the processing tool axis 2PA, the cylindrical surface 238 of the pressing ring 234 is first fitted from the shoulder portion 2102 of the can body 2101 into the outermost diameter portion in accordance with the forward movement (the approaching movement) of the processing table 22 with respect to the holding table 218.

Next, the pressing ring 234 comes into contact with the stopper member 239 so that further forward movement of the second housing 232 and the third housing 233 with respect to the holding table 218 and the can 2100 is restricted.

From this state, the processing table 22 moves further forward with respect to the holding table 218. Accordingly, the first housing 231 moves closer to the second housing 232 from the direction of the processing tool axis 2PA so that a distance between the first housing 231 and the second housing 232 in the direction of the processing tool axis 2PA is narrowed.

At this time, a cam roller (not shown) rolling on the inner peripheral surface of the first housing 231 in the center member cam roller mechanism 235 in the direction of the processing tool axis 2PA is pressed inward in the processing tool radial direction in response to the tapered shape of the inner peripheral surface of the first housing 231. Accordingly, the center member 222 connected to the center member cam roller mechanism 235 comes into contact with the inner peripheral surface of the neck portion 2104 of the can 2100 while moving closer to the outer member 223.

The cam roller (a portion denoted by reference numeral 236) rolling on the inner peripheral surface of the first housing 231 in the outer member cam roller mechanism 236 in the direction of the processing tool axis 2PA is pressed inward in the processing tool radial direction in response to the tapered shape of the inner peripheral surface of the first housing 231. Accordingly, the outer member 223 connected to the outer member cam roller mechanism 236 comes into contact with the outer peripheral surface of the neck portion 2104 of the can 2100 while moving closer to the center member 222.

Accordingly, when the embossing tool 221 rotates in the processing tool circumferential direction with respect to the can 2100 in a state where the neck portion 2104 of the can 2100 is sandwiched between the center member 222 and the outer member 223, predetermined embossing processing is performed on the neck portion 2104.

In the embodiment, in FIGS. 10 and 11, the screw forming processing tool 213 that serves as the center/outer member type rotational processing tool 213 corresponding to the large diameter rotational processing tool 29 is disposed in the second attachment hole 212 located on the processing procedure upstream side among the plurality of (two) second attachment holes 212 formed in the processing table 22. The embossing tool 221 that serves as the center/outer member type rotational processing tool 221 corresponding to the large diameter rotational processing tool 29 is disposed in another second attachment hole 212 located on the processing procedure downstream side 2P in relation to the second attachment hole 212 in which the screw forming processing tool 213 is disposed.

According to the processing table structure 220 of the can manufacturing apparatus of the embodiment, at least two or more second attachment holes 212 are provided in the processing table 22. The center/outer member type rotational processing tools 213 and 221 corresponding to the large outer diameter rotational processing tool 29 can be attached to at least two positions or more in the processing table 22. Accordingly, as will be described below, it is possible to process the can 2100 that could not be processed conventionally.

That is, it is possible to perform screw forming processing on the mouth portion 2103 of the can 2100 and to perform embossing processing on the neck portion 2104 at the time of manufacturing the long neck type bottle can.

At the time of performing embossing processing on the neck portion 2104 of the can 2100, the center/outer member type rotational processing tool 221 is used as the embossing tool 221 in the embodiment. Since both screw forming processing and embossing processing are performed on the can 2100, the processing table 22 is provided with two center/outer member type rotational processing tools 213 and 221 including the screw forming processing tool 213 that performs screw forming processing on the mouth portion 2103 of the can 2100 and the embossing tool 221 that performs embossing processing on the neck portion 2104.

In the embodiment, the processing table 22 is provided with at least two or more second attachment holes 212 and the large outer diameter rotational processing tools 29 (the center/outer member type rotational processing tools 213 and 221) are provided to correspond to the number of the second attachment holes 212 (that is, at least two types or more of rotational processing tool are provided).

Accordingly, the screw forming processing tool 213 is attached to one second attachment hole 212 among the plurality of second attachment holes 212 provided in the processing table 22 and the embossing tool 221 can be attached to another second attachment hole 212 located on the processing procedure downstream side P in the table circumferential direction in relation to the second attachment hole 212. Screw forming processing can be performed on the mouth portion 2103 of the can 2100 and then embossing processing can be performed on the neck portion 2104.

The positional relationship between the screw forming processing tool 213 and the embossing tool 221 in the table circumferential direction of the processing table 22 can be reversed to the above-described positional relationship. In this case, embossing processing is performed on the neck portion 2104 by the embossing tool 221 and screw forming processing is performed on the mouth portion 2103 by the screw forming processing tool 213.

According to the above-described embodiment, the plurality of large outer diameter rotational processing tools 29 (the screw forming processing tool 213 and the embossing tool 221) can be provided in the processing table 22 and thus both screw forming processing and embossing processing can be performed on the can.

In the embodiment, since at least one or more attachment holes 27 other than the second attachment hole 212 are disposed between the second attachment holes 212 adjacent to each other in the table circumferential direction of the processing table 22, the following operational effects are obtained.

The outer diameters of the center/outer member type rotational processing tools 213 and 221 are larger than the outer diameters of the other processing tools 26. For this reason, in the case of manufacturing the bottle can by performing screw forming processing on the mouth portion 2103 and performing embossing processing on the neck portion 2104, for example, when the second attachment hole 212 to which the screw forming processing tool 213 (the center/outer member type rotational processing tool located on the processing procedure upstream side) is attached and another second attachment hole 212 to which the embossing tool 221 (the center/outer member type rotational processing tool located on the processing procedure downstream side 2P) is attached are disposed adjacent to each other (next to each other) in the table circumferential direction without disposing any attachment hole 27 other than the second attachment hole 212 therebetween differently from the above-described configuration, there is a case in which the screw forming processing tool 213 and the embossing tool 221 interfere with each other so that either one of them may not be able to be attached to the processing table 22.

For that reason, in the embodiment, at least one or more attachment holes 27 other than the second attachment hole 212 are disposed between the second attachment holes 12 adjacent to each other in the table circumferential direction as in the above-described configuration. Accordingly, it is easy to prevent interference between the center/outer member type rotational processing tools 213 and 221 corresponding to the large outer diameter rotational processing tools 29 attached to the second attachment hole 212 and which are disposed adjacent to each other in the table circumferential direction (with a gap therebetween). The plurality of center/outer member type rotational processing tools 213 and 221 can be reliably attached to the processing table 22.

### Third Embodiment of can Manufacturing Apparatus and Processing Table Structure Thereof

Next, a processing table structure of a can manufacturing apparatus according to a third embodiment of the present invention will be described. A detailed description of components the same as those of the first and second embodiments will be omitted and only different points therefrom will be described below.

Although particularly not shown in the drawings, the can manufacturing apparatus of this embodiment is used for manufacturing a bottle can or an aerosol can. In the processing table structure of the can manufacturing apparatus, the processing table 22 is provided with at least two or more second attachment holes 212 each having an inner diameter larger than those of the other attachment holes 27. As the large outer diameter rotational processing tool 29 attached to the second attachment hole 212, at least two or more center/outer member type rotational processing tools 221 for embossing processing are provided.

The embossing tools 221 (the large outer diameter rotational processing tools 29) can be attached to the processing table 22 in response to the number of the second attachment holes 212 (that is, at least two types or more of embossing tool can be attached to the processing table). Accordingly, a plurality of types of embossing processing can be performed on the outermost diameter portion of the can body (the circumferential wall of the can).

According to the above-described embodiment, the plurality of large outer diameter rotational processing tools 29 (the embossing tools 221) can be provided in the processing table 22 and thus a plurality of types of embossing processing can be performed on the can. Thus, it is possible to process cans that could not be processed conventionally (particularly, it is possible to perform processing by the rotational processing tool 29).

In the embodiment, since at least one or more attachment holes 7 other than the second attachment hole 212 are disposed between the second attachment holes 212 adjacent to each other in the table circumferential direction of the processing table 22, the following operational effects are obtained.

In the case of manufacturing the bottle can or the aerosol can by performing a plurality of types of embossing processing on the can body, when the second attachment hole 212 to which the embossing tool 221 (the large diameter rotational processing tool 229 located on the processing procedure upstream side) is attached and another second attachment hole 212 to which the embossing tool 221 (the large diameter rotational processing tool 29 located on the processing procedure downstream side P) performing embossing processing different from that of the embossing tool 21 is attached are disposed adjacent to each other (next to each other) in the table circumferential direction without disposing any attachment hole 27 other than the second attachment hole 212 therebetween differently from the above-described configuration, there is a case in which the embossing tools 221 interfere with each other so that any one of them cannot be attached to the processing table 22.

For that reason, as in the processing table structure of the can manufacturing apparatus of the embodiment, it is desirable to dispose at least one or more attachment holes 27 other than the second attachment hole 212 between the second attachment holes 212 adjacent to each other in the table circumferential direction. Accordingly, it is easy to prevent interference between the large outer diameter rotational processing tools 29 (the embossing tools 221) attached to the second attachment holes 212 disposed adjacent to each other in the table circumferential direction (with a gap therebetween). A plurality of large diameter rotational processing tools 29 can be reliably attached to the processing table 22.

In the first to third embodiments of the present invention, the inventor of the present invention recognized the above-described problems and proposes a particular configuration in which at least two or more second attachment holes 212 are provided in the processing table 2 in order to exhibit excellent operational effects that can solve the problems. However, one skilled in the art who does not recognize the problems and the operational effects of the present invention should not unnecessarily increase the number of the second attachment holes 212 in the conventional processing table 22 for the following reasons.

That is, since the second attachment hole 212 is the attachment hole 27 to which the rotational processing tool 29 such as the large outer diameter center/outer member type rotational processing tools 213 and 221 is attachable, there is a possibility that the arrangement pitch between the plurality of attachment holes 27 arranged in the table circumferential direction may increase so that the size (the diameter) of the processing table 22 increases when the number of the second attachment holes 212 increases. When the diameter of the processing table 22 increases, the diameter of the holding table 218, of course, increases. When the sizes of the tables 22 and 218 increase, the container capacity is limited at the time of transporting the table or the strength of the main body frame of the can manufacturing apparatus needs to be increased or the output of the driving system needs to be increased in accordance with an increase in weight of the table. Accordingly, there is a possibility that various expenses may increase. Therefore, one skilled in the art who does not recognize the above-described problems and the excellent operational effects according to the present invention (that is, one who does not have motivation) could not have easily conceived of the present invention.

In the present invention, it is more desirable to set the number of the second attachment holes 212 provided in the processing table 22 to two in order to keep the table size as small as possible while the above-described operational effects are exhibited.

The present invention is not limited to the above-described embodiments and various modifications can be made without departing from the spirit of the present invention.

For example, in the above-described embodiments, a case has been described in which at least one or more attachment holes 27 other than the second attachment hole 212 are disposed between the second attachment holes 212 adjacent to each other in the table circumferential direction of the processing table 22, but the present invention is not limited thereto. Particularly, in the second and third embodiments, when a sufficient arrangement pitch between the second attachment holes 212 adjacent to each other in the table circumferential direction is secured, the attachment hole 7 other than the second attachment hole 212 may not be disposed between the second attachment holes 212.

In the above-described embodiments, a case has been described in which the third attachment holes 243 are adjacently disposed at both sides of the second attachment hole 212 in the table circumferential direction, but the present invention is not limited thereto. That is, for example, when a sufficiently wide arrangement pitch between the attachment holes 27 adjacent to each other in the table circumferential direction is secured, the third attachment hole 243 may be adjacently disposed only at one of the two sides of the second attachment hole 212 in the table circumferential direction. Alternatively, one of the first attachment hole 211 and another second attachment hole 212 may be adjacently disposed at both sides of the second attachment hole 212 in the table circumferential direction.

In the above-described embodiments, an example (the first embodiment) in which the screw forming processing tool 213 corresponding to the center/outer member type rotational processing tool is attached to the second attachment hole 212 of the processing table 22, an example (the second embodiment) in which the screw forming processing tool 213 and the embossing tool 221 are attached to the attachment hole, and an example (the third embodiment) in which various embossing tools 221 are attached to the attachment hole have been described, but the present invention is not limited to these examples. That is, the center/outer member type rotational processing tool other than the screw forming processing tool 213 and the embossing tool 221 may be provided in the second attachment hole 212 of the processing table 22.

In the above-described embodiments, a case has been described in which the center/outer member type rotational processing tools 213 and 221 corresponding to the large outer diameter rotational processing tool 29 are attachable to the second attachment hole 212, but the present invention is not limited thereto. That is, for example, an outer member type rotational processing tool without a center member may be used as the large diameter rotational processing tool 29 attachable to the second attachment hole 212.

In the first and second embodiments, the can manufacturing apparatus has been described as a bottle can manufacturing apparatus that manufactures a bottle can by performing various processes on a bottomed cylinder can. Further, in the third embodiment, the can manufacturing apparatus has been described as a bottle can manufacturing apparatus or an aerosol can manufacturing apparatus that manufactures an aerosol can by performing various processes on a bottomed cylinder can. However, the present invention is not limited to those examples and the can manufacturing apparatus may be a can manufacturing apparatus that manufactures a can other than a bottle can and an aerosol can.

Further, the processing table structures according to the first to third embodiments may be combined with the spindle rotation units described above with reference to FIGS. 1 to 9. Specifically, a part X of the processing table 12 shown in FIG. 2 may be provided with the second attachment hole 212 and the third attachment hole 243 similarly to the processing table 22 shown in FIG. 10 and at least two or more center/outer member type rotational processing tools 213 and 221 corresponding to the large outer diameter rotational processing tool 29 may be attached to the attachment holes. In this case, the other configurations may be the same as those of FIGS. 1 to 9.

In addition, the configurations (components) described in the above-described embodiments, modified examples, and supplements may be combined, other components may be added, or components may be omitted or replaced within the scope not departing from the spirit of the present invention. Further, the present invention is not limited to the above-described embodiments, and is limited only to the claims.

### INDUSTRIAL APPLICABILITY

According to the spindle rotation unit of the present invention, it is possible to easily dispose the corresponding driving motor for rotating the spindle even when the arrangement position of a spindle attached to any one of the plurality of attachment portions arranged in the base is changed.

Meanwhile, according to the processing table structure of the can manufacturing apparatus of the present invention, the large outer diameter rotational processing tool can be provided at a plurality of positions of the processing table. Accordingly, it is possible to variously process cans that could not be processed conventionally by, for example, manufacturing cans having different diameters using one can manufacturing apparatus, performing both screw forming processing and embossing processing on the can, or performing a plurality of types of embossing processing on the can.

Therefore, in any aspect, the present invention has industrial applicability.

### REFERENCE SIGNS LIST

12 Processing table (base)
13 Inner ring body
14 Outer ring body
15 Rib
17 Attachment hole (attachment portion)
17A Predetermined attachment hole (predetermined attachment portion)
19 Rotational processing tool (spindle)
110 Rotational processing tool driving structure of can manufacturing apparatus (spindle rotation unit)
112 Motor plate
113 Motor attachment flange
114 Driving motor
115 Transfer member
116 Belt tensioner
125 Opening portion
1MA Motor axis of driving motor (center axis of motor attachment flange)
1TA Table axis
22 Processing table
26 Processing tool
27 Attachment hole
28 Die processing tool
29 Rotational processing tool
210, 220 Processing table structure of can manufacturing apparatus
211 First attachment hole (standard diameter hole)
212 Second attachment hole (large diameter hole)
213 Screw forming processing tool (center/outer member type rotational processing tool)
218 Holding table
221 Embossing tool (center/outer member type rotational processing tool)
222 Center member
223 Outer member
243 Third attachment hole (small diameter hole)
2100 Can
2101 Can body (circumferential wall of can)
2TA Table axis

1. A spindle rotation unit comprising:
a motor plate;
a motor attachment flange that is attached to the motor plate;
a driving motor that is attached to the motor plate by the motor attachment flange; and
a transfer member that connects the driving motor and a spindle of a processing tool to be rotated by the spindle rotation unit and transfers a rotational driving force of the driving motor to the spindle,
wherein the motor attachment flange is provided with an opening portion through which the transfer member is inserted, and
wherein the motor attachment flange is disposed in the motor plate in a rotatable manner around an axis of the driving motor so that the opening portion is opened toward the spindle.

2. The spindle rotation unit according to claim 1,
wherein the transfer member is an annular belt,
wherein a belt tensioner is attached to the motor plate, and
wherein the belt tensioner is disposed in the motor plate so that its position is adjustable in response to the spindle.

3. The spindle rotation unit according to claim 1,
wherein the motor attachment flange has an arc shape and is attached to the motor plate while rotating around a motor axis of the driving motor so that its position is adjustable.

4. The spindle rotation unit according to claim 1,
wherein the driving motor is supported by the motor attachment flange in a region of at least 180° or more around the motor axis.

5. A table structure comprising:
the spindle rotation unit according to claim 1; and
a processing table to which the motor plate is attached,
wherein a plurality of tool attachment portions for selectively attaching the processing tool thereon are arranged in the processing table, and
the motor attachment flange is disposed in the motor plate in a rotatable manner around the axis of the driving motor so that the opening portion is opened toward the tool attachment portion to which the processing tool is attached.

6. The table structure according to claim 5,
wherein the processing table includes an inner ring body, an outer ring body that is disposed outward from the inner ring body in a table radial direction orthogonal to the table axis to be coaxial therewith, and a plurality of ribs that connect the inner ring body and the outer ring body in the table radial direction and are arranged at intervals in the table circumferential direction,
wherein the plurality of plate attachment portions are arranged in at least one of the outer ring body and the inner ring body for selectively attaching the motor plate the spindle rotation unit thereon so that the spindle rotation unit can rotate the spindle of the processing tool, and
wherein a width of the motor plate in the table circumferential direction is set to be smaller than a distance in the table circumferential direction between ribs adjacent to each other in the table circumferential direction.

7. A processing table structure of a can manufacturing apparatus in which a holding table and a processing table disposed to face each other repeatedly move closer to and away from each other in a table axial direction and are intermittently and relatively rotated in a table circumferential direction around a table axis and thereby sequentially process a bottomed cylinder can held by the holding table using a plurality of processing tools provided in the processing table in the table circumferential direction,
wherein the processing table is provided with a plurality of attachment holes arranged in the table circumferential direction so that the processing tools are attachable thereto,
wherein the plurality of tool attachment holes include a first attachment hole and a second attachment hole having an inner diameter larger than that of the first attachment hole, and
wherein at least two or more second attachment holes are provided in the processing table.

8. The processing table structure of the can manufacturing apparatus according to claim 7,
wherein at least one or more attachment holes other than the second attachment hole are disposed between second attachment holes adjacent to each other in the table circumferential direction of the processing table.

9. The processing table structure of the can manufacturing apparatus according to claim 7,
wherein the plurality of tool attachment holes are arranged at equal intervals in the table circumferential direction,
wherein the plurality of attachment holes include a third attachment hole having an inner diameter smaller than that of the first attachment hole, and
wherein third attachment holes are respectively adjacently disposed on both sides of the second attachment hole in the table circumferential direction.

10. The processing table structure of the can manufacturing apparatus according to claim 7,
wherein the plurality of processing tools include a die processing tool that performs die processing on a can while moving in a can axial direction and a rotational processing tool that performs rotational processing on a can while rotating around a can axis,
wherein at least a center/outer member type rotational processing tool is provided as the rotational processing tool and the center/outer member type rotational processing tool includes a center member that is disposed to face an inner peripheral surface of a circumferential wall of a can and an outer member disposed to face an outer peripheral surface of the circumferential wall of the can and gives a predetermined shape to the circumferential wall by sandwiching the circumferential wall of the can while moving the center member and the outer member closer to each other, and
wherein the center/outer member type rotational processing tool is attachable to the second attachment hole.

11. The processing table structure of the can manufacturing apparatus according to claim 10,
wherein a screw forming processing tool is provided as the center/outer member type rotational processing tool.

12. The processing table structure of the can manufacturing apparatus according to claim 10,
wherein an embossing tool is provided as the center/outer member type rotational processing tool.

13. The table structure according to claim 5,
wherein the plurality of tool attachment portions are arranged over an entire periphery of the processing table in the table circumferential direction around a table axis.

14. A bottle necker, comprising the processing table structure according to claim 5.

15. A processing table for a can manufacturing apparatus, comprising:
an inner ring body,
an outer ring body that has a plurality of tool attachment portions arranged in a table circumferential direction so that processing tools can be selectively attached thereto, the outer ring body being disposed outward from the inner ring body in a table radial direction orthogonal to the table axis to be coaxial therewith,
a plurality of ribs that connect the inner ring body and the outer ring body in the table radial direction and are arranged at intervals in the table circumferential direction, and
a plurality of plate attachment portions arranged in the table circumferential direction in at least one of the outer ring body and the inner ring body for selectively attaching a spindle rotation unit thereon so that the spindle rotation unit can rotate a spindle of the processing tool attached on the selected tool attachment portions.

16. The processing table according to claim 15, wherein the distance in the table circumferential direction between the ribs adjacent to each other is larger than the width of the spindle rotation unit in the table circumferential direction, and the spindle rotation unit can be disposed between the ribs when the spindle rotation unit is attached on the selected plate attachment portion

17. The processing table according to claim 15, wherein the plate attachment portion comprises a plate attachment hole group.
